(19) United States
(12) Patent Application Publication
(10) Pub. No.: US 2014/0071456 A1
(43) Pub. Date: Mar. 13, 2014

(54) MULTIPLE PATHS MEASURING AND IMAGING APPARATUS AND METHOD

(71) Applicant: University of Kent, Kent (GB)

(72) Inventors: Adrian Podoleanu, Kent (GB); Mantas Zurauskas, Kent (GB); John Rogers, Kent (GB)

(73) Assignee: University of Kent, kent (GB)

(21) Appl. No.: 14/025,970

(22) Filed: Sep. 13, 2013

(30) Foreign Application Priority Data
Sep. 13, 2012 (GB) GB 1216332.5

(51) Int. Cl. G01B 9/02

(52) U.S. Cl. CPC G01B 9/0209
USPC 356/497

(57) ABSTRACT

The invention discloses an optical interferometer which can be used to provide simultaneous measurements over multiple path lengths and methods to employ such an interferometer as to achieve a variety of functions covering simultaneous measurements at different depths separated by an increment of a multiple differential delay in the interferometer as well as simultaneous polarization measurements from a given depth and imaging. Configurations and methods are presented to encode the axial length in an object under investigation using frequency shifting as well as chirping the frequency of signals determining the frequency shifting. Methods are disclosed on the combination of multiple path configurations as to achieve versatile functionality in measurements, by using either broadband excitation or swept source excitation, combined with either discreet frequency shifting or chirped frequency shifting. Under swept source excitation, the invention discloses a long axial range apparatus, with constant sensitivity.

### 1. FIELD OF THE INVENTION

The present invention relates to an optical interferometer which can be used to provide simultaneous measurements and simultaneous optical coherence tomography (OCT) images over multiple path lengths, using principles of low coherence interferometry or spectral interferometry.

### 2. BACKGROUND AND PRIOR ART

There is an interest in OCT of speeding up the acquisition to cope with moving targets. Also, in the field of sensing, there is a need to collect data from multiple points simultaneously. The configurations disclosed in patent number U.S. Pat. No. 6,775,007 B2 by Izatt et al. employ versions of cascaded Mach-Zehnder interferometers in conjunction with frequency shifters to create multiple path length differences associated with unique frequencies. Such a configuration presents the following disadvantages: (i) different states of polarization cannot be associated with unique carrier frequencies; (ii) in integrated formats, optical delays cannot be easily adjusted; (iii) after passing a train of cascaded interferometers, the intensity in channels corresponding to different carrier frequencies present unequal optical intensities. As each phase element introduces a separate frequency shift, the configuration is complex and not reconfigurable in terms of functionality.

The article “Acousto-optically switched optical delay lines” published by Naabel A. Riza in Optics communications 145 (1998), pages 15-20 presents several configurations of optical delay lines devised for telecommunications that employ acousto-optic deflectors to scan and de-scan the laser beam to achieve different delays. Such an embodiment has the following disadvantages: (i) employs a single frequency with spectral scanning in time to achieve different delays, a procedure that is time consuming; (ii) different polarization states that cannot be associated with unique carrier frequencies.

In order to speed up the acquisition of time domain (TD)-OCT, a method and systems are disclosed in the PCT application WO/2009/106884A1 UKPO, 0803559.4, and US US20110109911 by Podoleanu, where an active recirculating loop is placed in each interferometer arm together with a frequency shifter, where the two frequency shifters are driven at different frequencies so as to encode signal from successive depths in the object investigated on the frequency difference between the two frequencies, and where the depth positions are separated by the differential optical path difference of the two recirculating loops. To alleviate the attenuation at each round trip, optical amplification is used. Despite the employment of amplifiers in the secondary loops to compensate for losses, only up to twenty recirculations could be produced and good signal to noise ratio images from five depths only could be obtained, as presented in the paper Multiple-depth en-face optical coherence tomography using active recirculation loops, published by L. Neagu, A. Bradu, L. Ma, J. W. Bloor and A. Gh. Podoleanu in Optics Letters Vol. 35, No. 13/Jul. 1, 2010, pp. 2296-2298. Two major causes for failure to achieve more channels is believed to be due to the ASE built up in the secondary loops and also owing to polarization mismatch.

The configurations disclosed in the patent by Podoleanu above presents the following disadvantages:
1. From a round trip to the next, the interference signal decayed by more than 4 dB, leading to decay from channel to channel in depth to the same extent.
2. Multiple states of polarization could not be associated with multiple roundtrips along the multiple paths.
3. The depth was encoded on the frequency shift imprinted by the number of wave passages through frequency shifters. This limited the applicability of the configuration.
4. The object in OCT imaging is a multiple reflector, and the recirculating loop in the object arm creates multiple replicas. Out of the multiple replicas sent to the multilayer object, only one of these replicas is practically used to produce image from a certain depth in the object. It appears to be inappropriate to split the object arm and send multiple replicas to a target that will return multiple replicas itself.
5. Optical amplification introduced ASE noise.

Sequential collection of images is performed in the practice of structured illumination microscopy, as described in “Structured interference optical coherence tomography” by Ji Yi, Qing Wei, Hao F Zhang, and Vadim Backman published in Optics Letters, 37/15, 2048-3050, 2012. In this paper, 10 frames of spectral OCT images are collected, for 10 different phases of the modulation pattern created in the image by rotating a chopper in the reference arm. The disadvantage of such method is that sequential collection of images takes time, which renders it inappropriate for moving targets. It would save time if all mages were collected simultaneously.

Another problem is that of decay of sensitivity with depth in spectral OCT. A multiple path configuration with secondary loops in each interferometer arm, as disclosed in US US20110109911, was demonstrated in the paper “Extra long imaging range swept source optical coherence tomography using re-circulation loops”, published in Opt. Express 18, 25361-25370 (2010), by A. Bradu, L. Neagu, A. Podoleanu. This could reduce the decay with depth. However, the method presents the disadvantage of ASE and cost, and while the method can enlarge the axial range of spectral OCT by a large number, over 20-100 times the axial range in a conventional OCT configuration, in practice, extension by a factor of 2-3 of the axial range only would suffice.

The present invention therefore seeks to overcome the above disadvantages, by providing novel enhanced configurations and methods of operation. The novel features incorporated herewith lead to more uniformity between at least some of the channels corresponding to different depths, better control of polarization for at least a limited number of channels and better efficiency in using the signal. The present invention ensures that from within at least some adjacent layers in depth, the strength of signal is similar and strong. In addition, some of the embodiments disclosed are reconfigurable, allowing different functionality to be achieved with minimum changes.

Simultaneous collection of images for multiple depth interrogation, multiple polarization interrogation, structured illumination and despeckle are achieved in more compact, lower cost, lower noise embodiments.

In spectral interferometry embodiments proposed, constant decay with depth or lower attenuation with depth is obtained by using a limited number of parallel channels which make such embodiments more compact and confer such embodiments lower cost.

In a majority of embodiments disclosed here, the depth is encoded on the pulsation frequency of the interference photodetected signal. By providing extra means to encode the depth, where the frequency shifters are placed outside the optical rings, more compact rings and lower costs configurations are allowed, with further functionality.

In the prior art documents mentioned above, frequency shifters are driven at fixed frequencies. This limited the functionality of the interferometers. In some of the embodiments presented, by chirping the frequency shifts when applying frequency shifting of signals to be interfered, more functionality is obtained as presented below, further alleviating the disadvantages of the known technologies.

### 3. SUMMARY OF THE INVENTION

In a first aspect, the present invention discloses optical interferometer configurations that can provide interference along parallel optical delays. Such configurations can be customized to ensure that a number of OCT channels simultaneously provide signal from several optical path differences within a sensing volume, all exhibiting similar strength.

In a second aspect, the present invention provides means for ensuring that a number of channels provide signal from the same depth, but with different polarization states, all exhibiting similar strength. Such means can be used to produce simultaneous polarization measurements from a given axial position within the sensing volume or a polarization sensitive OCT image from a given depth in the object investigated. The invention can also be used to supply polarization data from several depths simultaneously.

In a third aspect, the invention relates to interferometer configurations where means of creating parallel delay paths, that ensure similar signal strength, are combined with means of creating roundtrip paths, characterized by decaying signal strength.

In a fourth aspect, the invention provides a novel optical source for the multiple path configuration, where the source itself contains multiple paths that in combination with the multiple paths in the reference path of the interferometer can simultaneously provide signals from several axial positions in the object investigated.

In a fifth aspect, the present invention provides interferometer configurations containing multiple delays interleaved between frequency shifters driven by signals with synchronized chirping that are employed to encode the axial position in an object, on the frequency of the interference signal resulting from interfering delayed chirped signals.

In a sixth aspect, the invention discloses methods for encoding axial depths in an object on the frequency of the interference signal, resulting from frequency shifting of parallel optical beams traversing different optical path depths in the interferometer.

In a seventh aspect, the invention discloses methods for encoding polarization states of signals returned from different depths and where polarization and depth information are encoded on the frequency of the photodetected interference signal.

In an eighth aspect, the invention protects the combination of chirping the optical frequency of the optical signals in the two interferometer arms, with principles of low coherence interferometry or spectral interferometry.

In a ninth aspect, the invention presents methods to encode axial distances in the object to be investigated by a multiple delays interferometer while synchronously chirping the frequency of the interfering signals.

In a tenth aspect, a multiple phase element is disclosed, where different optical lengths are provided in parallel in multiple beams between two acousto-optic modulators, each driven by a beam of a different frequency as determined by the frequency of signals applied to the two modulators.

In an eleventh aspect, a multiple phase element is disclosed, where different optical lengths are provided in multiple beams between an acousto-optic modulator driven by a set of multiple frequencies, and a mirror.

In a twelfth aspect, a polarization sensitive multiple phase element is disclosed, traversed by both the interfering beams in a two beam interferometer.

In a thirteenth aspect, the invention presents methods to employ a tunable laser source and multiple paths to provide multiple depth imaging and multiple depth measurements from an object.

In a fourteenth aspect, the invention discloses an apparatus and methods to provide constant sensitivity with depth or longer axial depth range in spectral OCT.

In a fifteenth aspect, the invention discloses a fast apparatus and methods to collect the multiple phase shifted images in structured illumination microscopy.

### 4. BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described in association with the accompanying drawings in which:

FIG. 1 shows, in diagrammatic form, the main elements of the apparatus according to the invention.

FIG. 2 shows, in diagrammatic form, a first embodiment according to the invention, of a multiplexer using a frequency shifter driving a multiple phase element made of multiple paths.

FIG. 2a shows a detailed diagram of the multiplexer in FIG. 2 where the multiple paths are essentially of equal length but each prepares a different polarization state.

FIG. 2b shows a detailed diagram of the multiplexer in FIG. 2 where the multiple paths exhibit stepped delays and are essentially of similar polarization.

FIG. 2c shows a detailed diagram of a multiplexer as a combination of those in FIG. 2a and FIG. 2b.

FIG. 2d shows, in diagrammatic form, a second embodiment according to the invention, of a multiplexer using frequency shifted multiple paths.

FIG. 2e shows, in diagrammatic form, another version of the second embodiment according to the invention, of a multiplexer using frequency shifted multiple paths.

FIG. 2f shows, in diagrammatic form, yet another version of the second embodiment according to the invention, of a multiplexer using frequency shifted multiple paths.

FIG. 2g shows, in diagrammatic form, a multiplexer according to the invention, containing any of embodiments 2a,b,c,d,e or f above, in series with an active ring.

FIG. 2h shows, in diagrammatic form, a multiplexer according to the invention, containing an active ring that includes a multiplexer according to the embodiment in FIG. 2a or 2b.

FIG. 2i shows, in diagrammatic form, a multiplexer according to the invention, containing a multiple phase element implemented as a passive ring, combined with a multiplexer according to the embodiment in FIG. 2a or 2b.

FIG. 2j shows, in diagrammatic form, a multiplexer according to the invention, containing a multiple phase element implemented as a passive ring in series with a frequency shifter.

FIG. 3a shows a detailed diagram of a first embodiment of the apparatus according to the invention based on the embodiment in FIG. 2a used for polarization sensitive OCT imaging.

FIG. 3b shows a detailed diagram of a second embodiment of the apparatus according to the invention based on the embodiment in FIG. 2b used for simultaneous multiple depth OCT imaging.

FIG. 4a shows in diagrammatic form, a third embodiment of the apparatus according to the invention, based on a multiplexer disclosed in FIG. 2g.

FIG. 4b shows in diagrammatic form, the succession of interference wave trains output of the apparatus in FIG. 4a for M=11 recirculations through the ring and P=2 parallel paths.

FIG. 4c shows in diagrammatic form, another version of the third embodiment of the apparatus according to the invention, similar to that in FIG. 4a, where the object is part of the object multiplexer.

FIG. 5a shows in diagrammatic form, a fourth embodiment of the apparatus according to the invention, based on a multiplexer as disclosed in FIG. 2h.

FIG. 5b shows the intensity of frequency of the multiple interference terms created by the embodiment in FIG. 5a for M=4 recirculations through the rings and P=2 parallel paths.

FIG. 5c lists the frequency and optical path pairs created by the embodiment in FIG. 5a for M=4 recirculations and P=2 parallel paths.

FIG. 5d shows in diagrammatic form, another version of the fourth embodiment of the apparatus according to the invention, similar to that in FIG. 5a, where the object is part of the object multiplexer.

FIG. 6 shows a fifth embodiment of the apparatus according to the invention, where an optical ring is placed within the optical source driving an interferometer equipped with a multiplexer in the reference path only.

FIG. 7a shows in diagrammatic form, a seventh embodiment of the apparatus according to the invention where the frequency shifting is placed outside the multiple phase element.

FIG. 7b shows the theoretical power output from a ring based on a single coupler design for two values of the cross coupling ratio relative to the power of the input pulse, left: 10% and right: 1%.

FIG. 7c shows another version of the embodiment in FIG. 7a.

FIG. 8a shows in diagrammatic form, an eight embodiment of the apparatus according to the invention, where the frequency shift is outside the multiple phase element, based on blocks as disclosed in FIG. 2i.

FIG. 8b shows in diagrammatic form, the succession of interference wave trains output of the embodiment in FIG. 8a.

FIG. 9a shows a ninth embodiment of the apparatus according to the invention, where frequency shifting is outside the multiple phase element and frequency chirping is used.

FIG. 9b presents the temporal variation of the frequency shifts of the two frequency shifters in FIG. 9a.

FIG. 9c shows another version of the embodiment in FIG. 9a.

FIG. 9d presents the temporal variation of the frequency shifts of the two acousto-optic frequency shifters in FIG. 9c.

FIG. 10 shows in diagrammatic form, an embodiment of the apparatus according to the invention, where the frequency shifting is outside the multiple phase element, implemented using a birefringent ring.

FIG. 11 illustrates the relative variation of the RF frequency applied to the frequency shifters in FIGS. 9a and 9c together with the optical frequency variation due to tuning the tuneable source.

### 5. DETAILED DESCRIPTION OF THE PREFERRED EMBODIMENTS

Various features of the present invention, as well as other objects and advantages attendant thereto, are set forth in the following description and the accompanying drawings in which like reference numerals depict like elements.

All lengths below are optical and they include the index of refraction of the fiber link or air or of the object.

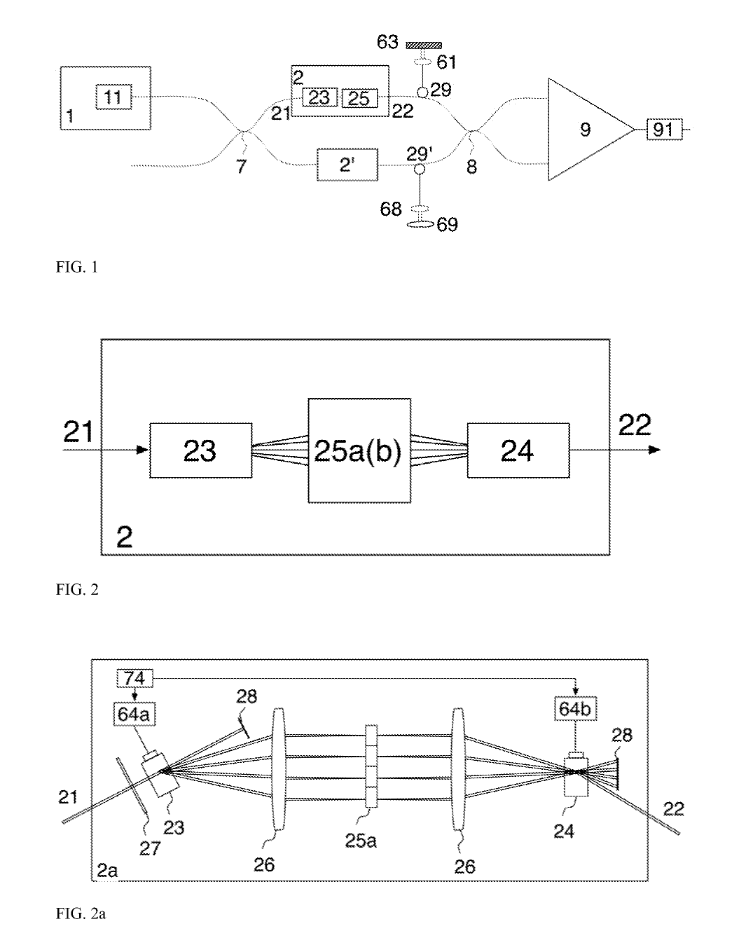

FIG. 1 shows, in generic diagrammatic form, the main principle of the invention, where light received from an optical source block, 1, incorporating a light source, 11, is divided into two beams, along a bottom path, object, and along an upper path, reference, of an interferometer, using a first splitter 7, the two paths being brought back together into a second splitter 8. The interferometer includes a multiplexer 2, placed in transmission in one of its arms, shown here in the reference arm. The light in the interferometer arms travels along a main object arm and a main reference arm. The main reference arm includes a third splitter, 29, shown in FIG. 1 in the form of a fiber circulator, 29, sending light to a focusing element, a lens, 61, and to a reference mirror, 63. The main object arm includes a fourth splitter, shown in FIG. 1 in the form of a fiber circulator, 29′, sending light to an interface optics, 68, and to an object under test, 69, to be imaged by OCT, excised tissue or in-vivo tissue in medical applications or composite structures in industrial applications or objects of art subject to conservation or any other object where there is an interest of collecting information from inside its volume non-invasively, or for sensing, such as in optical time domain reflectometry (OTDR). According to the invention, the multiplexer contains a frequency shifter, 23, that drives a multiple optical phase element, 25.

Characteristic to the invention, is that each element in 25 is traversed by a wave from 23 of distinct optical frequency. As disclosed below, the combination of frequency shifter and multiple phase element 25 can be implemented in parallel, where 23 creates spatially diverse waves, in parallel, each traversing a different phase element in an array 25 of phase elements.

A sequential implementation is also disclosed, where 23 is driven by a signal with chirped frequency and as consequence, sends waves of different optical frequencies, where sequentially, different phases are interrogated, created by an optical ring implementation of 25. To compensate for dispersion, a block 2′ is inserted in the reference path, incorporating similar elements as those employed in 2 depending on the particular embodiment. Multiple measurements in the object 69 are performed based on the frequency characterizing the wave traversing each phase element in 25. They are decoded using a decoder 91. The multiple measurements refer to multiple depths in the object 69, or multiple polarization information from the same depth, or a combination of several depth characterized in terms of polarization, or multiple phases for despeckle, or multiple phases/and or polarization for structured light. An optical path difference in the main loops, OPD_{M} refers to the difference of paths between the main paths.

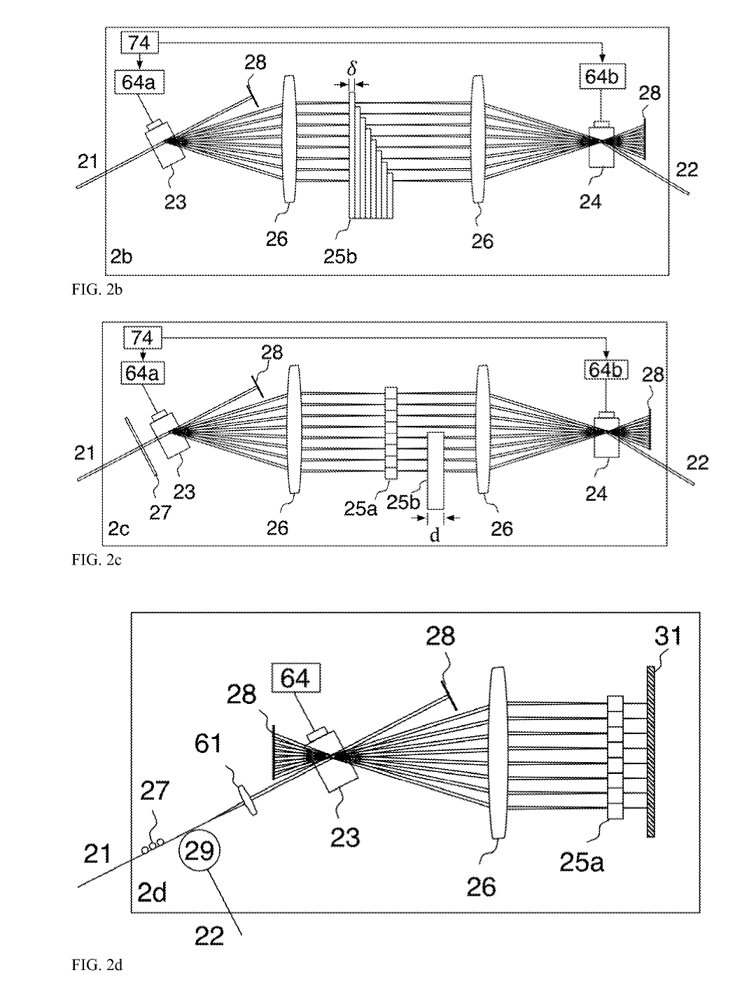

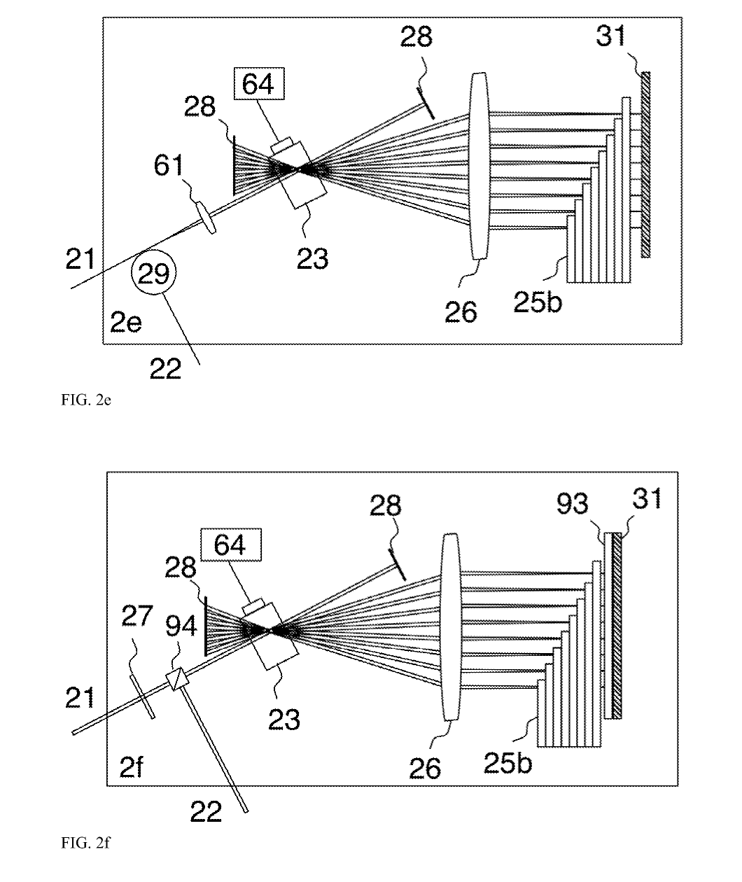

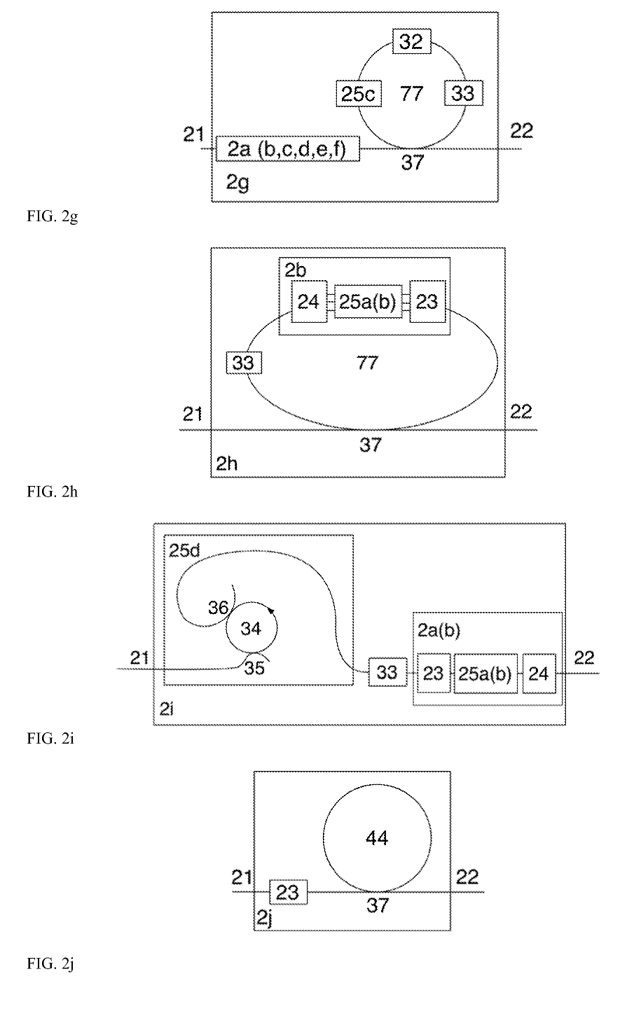

In terms of polarization control and more uniform decay from one channel to the next, an embodiment according to the present invention for the multiplexer, 2, with delays in parallel, is disclosed in FIG. 2. This operates in transmission, from input 21 to output 22, and contains two acousto-optic modulators (AOM)s, 23 and 24, and a multiple phase element, 25. For maximum efficiency, the AOMs use the first order of diffraction, although other orders can be used. The AOM 23 diffracts the incoming optical power into several directions, corresponding to the different phase gratings created by the multiple signals of different frequency applied to it. The emerging beams in other diffraction orders, including zero, are blocked using means known in the art.

In principle, more than 8 RF signals of different frequencies can be applied to AOMs, the only limitation being the RF power accepted by the crystals. As presented below, if two signals only are used, then these allow polarization functionality, whilst 4 signals can deliver Stokes information and in principle, the parameters of a Mueller matrix can be measured by using up to 16 channels.

FIG. 2a discloses a first embodiment of the multiplexer using parallel paths. A frequency shifter, 23 is employed, implemented using an acousto-optic modulator (AOM) 23. The RF excitation of the AOM, 23 consists in a number of P radio frequency (RF) signals of different frequencies, fₚ, provided by a driver 64a. This produces angular spatial separation of P beams, according to the frequency of the signal applied to 23 by the driver 64a. The AOM 23 deflects the input beam 21 into P beams in different directions.

A first lens 26, placed at a distance equal to its focal length from the AOM 23, redirects the P beams parallel to each other before the multiple phase element 25a. A second lens 26 is positioned at a distance equal to the summation of focal lengths of lens 25 with focal length 26 and behind it, at a distance approximately equal to its focal length, a second AOM element, 24, is placed. The effect of the lens 26 and AOM 24 is to bring all diffracted beams along the same axis after the AOM 24, in a recombined beam in the first order diffracted light. To do this, the same set of signals is applied to 24 using a driver 64b, under control of an optional synchronizing generator 74. Screens 28 block the zero order beams at the outputs of the AOMs 23 and 24. Each diffracted beam, shifted in frequency by fₚ, is intercepted by a phase delay element 25a, made from P phase elements, placed between the lenses 25 and 26. Only four such phase elements are shown as an example in FIG. 2a.

The technology of AOMs is well known by the person skilled in the art. Typical drivers with synthesizers of eight frequencies whose frequency and phase can be easily controlled, are commercially available from Gooch and Housego, Fla., USA.

To avoid cross talk between the channels, the beams coming out of 23 need to be separated spatially by more than the incident beam diameter. Lens 26, therefore, needs to have a long focal length. This may, however, make the delay block 2a too long. The diagram in 2a may contain an extra focusing element, according to means known in the art, to compensate for the beam divergence coming out after the second lens 26, in order to reduce the size of the block 2a.

For measurement of Stokes parameters for instance, the four phase elements in 25a in FIG. 2a prepare the state of polarization as linearly oriented at 0, 45 and 90 degrees and circular. This is achieved by injecting linear polarization into the first frequency shifter 23, using a linear polarizer 27. The 1^{st} phase element in 25a is a neutral glass block, the 2^{nd} phase element is a half wave plate rotated at 22.5 degrees, the 3^{rd} element is a half wave plate rotated at 45 degrees and the 4^{th} element is a quarter wave plate with the axes at 45 degree orientation from the direction of vibration determined by 27, to create circular polarized light. All four phase elements are cut with similar thickness to exhibit equal optical paths. More phase plate elements than those shown in FIG. 2a may be used, to compensate for the birefringence of the AOMs, in order to achieve the exact polarization state, according to means known in the art.

A simpler version of the embodiment in FIG. 2a can have only two phase elements in 25a to produce linear polarizations at 90 degrees: (i) a half wave plate rotated at 45 degrees with respect to the fast axis of the polarizer 27 and (ii) a slab of glass of similar optical thickness to the half wave plate. This simpler operation may allow for easier control of the AOM residual birefringence. In this case, the two polarization states may be aligned with the ordinary and the extraordinary axes of the AOM crystal used in 23. An optic slab may also be added to one of the beams to compensate for the different path difference incurred by the two polarization states propagating through the AOMS, 23 and 24. In this case, Stokes components cannot be inferred, but polarization insensitive information, birefringence and optical axis orientation can still be obtained.

Using the embodiment in FIG. 2a, polarization sensitive OCT imaging is achievable using fiber optics splitters and 2, 4 or 16 phase elements.

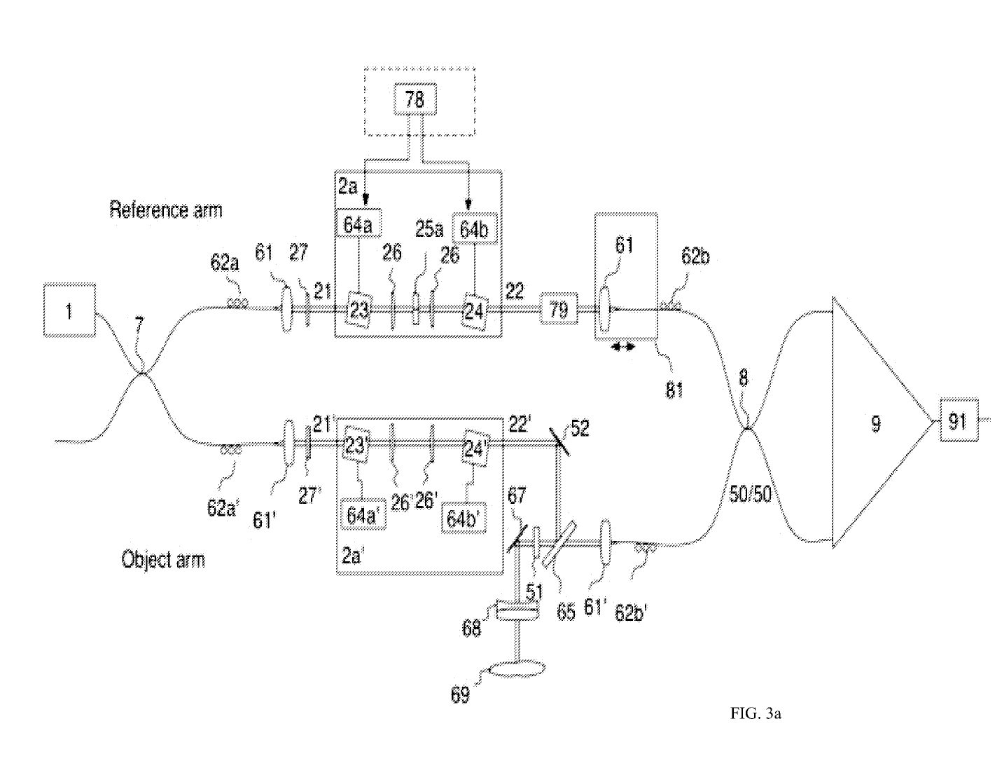

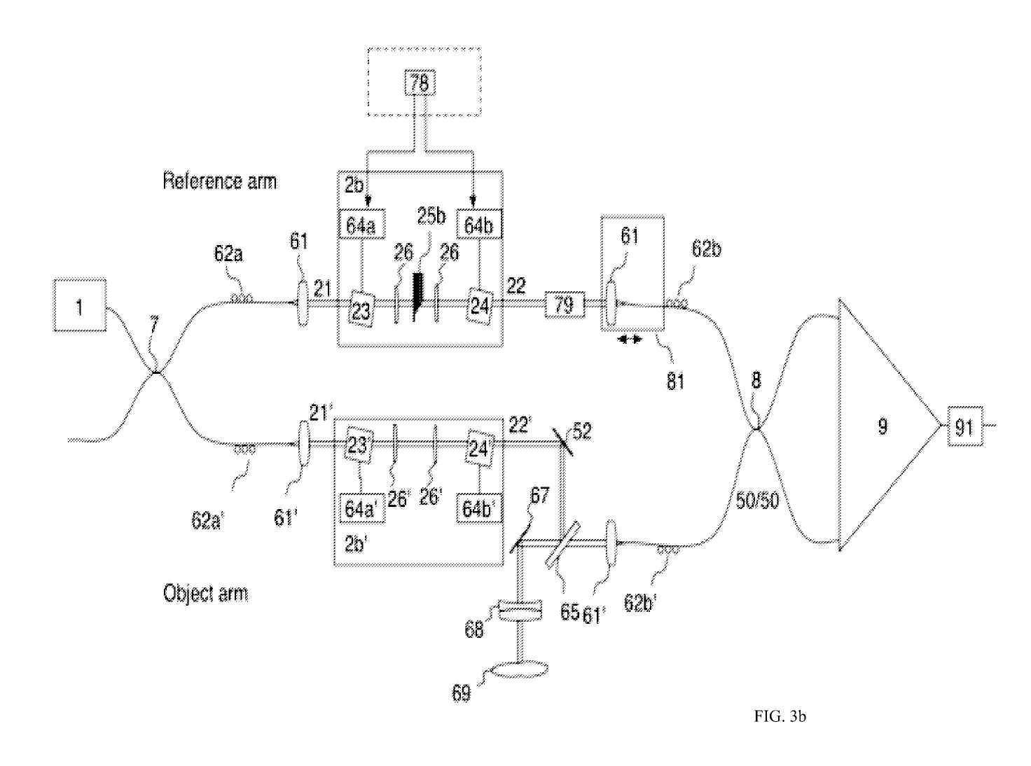

An embodiment of the apparatus according to the invention using blocks 2a in the two arms of an interferometer is shown in FIG. 3a.

A different implementation of the multiple phase element, 25b, is disclosed in FIG. 2b, where for measurement at different depths in the object 69, the phase elements are made of glass or other optical transparent material, shaped in the form of a stair, where each diffracted beam by the AOM 23, travels through a single stair of uniform optical thickness. Each stair may have either different optical thickness or the same thickness but different index of refraction. Either way, preferably, the differential delay from one step to the next is by the same increment, Δ. For ideal dispersion compensation, the multiple phase elements 25b may be made from similar material to that of the object investigated, 69. An embodiment of the apparatus according to the invention using blocks 2b is shown in FIG. 3b.

A combination of functionalities delivered by the embodiments in FIGS. 2a and 2b is presented in FIG. 2c. Here, the multiple phase elements are a combination of polarization elements 25a of similar thickness and of different thickness but similar polarization, 25b. FIG. 2c presents for simplicity, an element 25a made from 4 phase elements, to intercept the 1^{st} to the 4^{th} diffracted beams and a replication of the same, 4 phase elements, to intercept the 5^{th} to the 8^{th} diffracted beams. For simplicity, one stair for 25b is used only, in the form of a slab of optical thickness d. In practice, more elements than 4 are possible for 25a and more than one step stair for 25b. When a similar block 2, with no phase elements, 25a nor 25b, is placed in the other interferometer arm, simultaneous polarization interrogation from two different depths separated by d is achieved. The channels corresponding to beams traveling through the first 4 phase elements in 25a, from 1 to 4, are used to produce Stokes components from depth d₁ whilst the channels corresponding to beams 5 to 8 traveling through the next 4 phase elements in 25a, are used to produce Stokes components from a depth d₂, where the difference between d₁ and d₂ is d. FIG. 2d shows an embodiment of the multiple delay path block, 2, operating in reflection. Here, light from input beam 21 feeds a circulator 29 wherefrom light is directed into an AOM, 23, which diffracts the light into multiple channels. For several signals of different frequency applied to the AOM 23 by the driver 64, several diffracted light beams propagate through the lens 26 and then through different polarization controlling elements in 25a, reaching a mirror 31. The beams then propagate back through the same elements 25a, and are recombined and reinjected back into the circulator 29, exiting the block 2d via fiber 22. This embodiment produces multiple delays of similar optical path length, but of different polarization state, achieving the same functionality as the multiple phase element in FIG. 2a.

Another version of a multiple delays block in reflection is disclosed in FIG. 2e. Here the delay block 25b is replaced with different lengths of the optical phase control elements 25b, which enable delaying the diffracted beams along different lengths in steps of Δ. This embodiment produces multiple delays of essential similar polarization and allows similar functionality to that of the block in FIG. 2b.

Another version of a multiple delays block in reflection is disclosed in FIG. 2f. Here a polarization bulk splitter 94 is used. A quarter wave plate 93 in front of mirror 31, rotates the helicity of the incoming waves by 90 degrees and thus the light from recombined beams returned through the AOM 23, presents a linear polarization direction perpendicular to that of the incoming beam, 21 via 27, and therefore is sent by the polarization beam splitter 94 to the exit 22.

All embodiments disclosed in FIG. 2a, 2b, 2c, 2d, 2e, 2f present the advantage that, when included into the reference arm of interferometer configurations to be presented below, lead to similar strength of the interference signal obtained in each parallel channel, customized to provide either polarization or depth information, or both. There is no ASE involved. Possible problems may arise due to intermodulation between the RF signals applied to the AOMs, 23 and 24, however this can be reduced or even avoided by careful choice of frequency and phase values of the signals applied to them, and utilization of special acousto-optic materials.

FIG. 2g shows another embodiment of the multiplexer, 2, using a splitter, 37, to launch light into a ring, 77, combined with any multiplexer according to the description in FIG. 2b, 2c, 2d, 2e or 2f. The ring may be equipped with a frequency shifter 32, an optical amplifier 33 and an adjustable delay element 25c. These elements may not all be present, for instance the ring 77 may also be passive, ie with no optical amplification (no 32), as disclosed below. The amplifier 33 may contain optical isolators or not for larger amplification in the ring 77. For a length of the ring, L, each such multiplexer 2g produces multiple phase changes, composed from M recirculations, of roundtrip length mL, m=1, 2, . . . M, . . . around the ring combined with multiple phase changes, P, for p=1, 2, . . . P in the block 2b (or 2c, 2d, 2e or 2f).

Another embodiment, which combines a ring with parallel paths, is shown in FIG. 2h. Here, a directional coupler 37 is used to inject light into a ring, 77, equipped with a block 2b. To compensate for losses due to the cross efficiency of splitter 37, an optical amplifier, 33, equipped with optical isolators (or not, if stray reflections are tolerated by the active medium) can be used.

By using passive loops that can ensure little decay from one circulation to the next, there is no need for any optical amplification. The ASE problem is also eliminated by removing the optical amplifiers from the rings. To make such a scheme workable, frequency shifters are placed outside the rings to avoid losses and the scheme requires utilization of a power optical source 10, pulsated, with a pulse width τ, slightly less than the round trip time, Δt, in the loop. FIG. 2i contains such a ring, 34, where the cross coupling efficiency of splitter 35 and 36 is small, let us say 1%. This means that the power in the loop 34 will decay by 2% at each roundtrip.

FIG. 2j discloses a multiplexer containing a multiple phase element implemented as a passive ring, 44, in series with a frequency shifter, 23. In some embodiments, the frequency shifter is after the passive ring or before, without departing from the scope of the invention. In some other embodiments, the passive ring uses the multiple phase element 25d shown in FIG. 2i.

FIG. 3a discloses a detailed embodiment of the apparatus according to the invention. The light from the optical source block 1 is split into a reference arm (top) and an object arm (bottom) by a fiber beam splitter 7. A multiplexer based on the embodiment in FIG. 2a is used in the reference arm. The light in the reference arm then passes through the multiple phase element 25a. A similar block 2a′ is placed in the object path of the interferometer, where the two AOMs, 23′ and 24′ are driven at single frequencies and no other phase element 25 is used in between. For dispersion compensation, a similar path length of acousto-optic material in AOMS 23, 24, 23′ and 24′ and of fibers should be incorporated in the reference and object arms. The light from the object arm is then recombined with the light from the reference arm in the directional fiber (2^{nd} splitter) 8 and is detected by the balanced detection receiver 9. This contains two photodetectors and a differential amplifier to perform balance photodetection of the optical signals at the output of the splitter 8. The phase of light in each channel, p, is modified by the optical phase elements in the block 25a.

Light in the two arms is directed via polarization controllers 62a and 62a′, then via launchers 61 and 61′ containing lenses or converging mirrors towards two linear polarizers 27 and 27′ oriented so that the resulting linear polarization coincides with the required polarization of AOM elements, 23, 24 in 2a and 23′ and 24′ in 2a′ for optimal performance. In the reference arm, multiple phase gratings with different periods and adjustable contrasts are created in the AOM elements 23 and 24 by driving them with sinusoidal signals of different frequencies simultaneously. The beam in the reference arm passes a dispersion compensator element, 79, which compensates for the dispersion introduced in the object arm by extra elements, as presented immediately below, and is then injected into the fiber coupler 8, via a focusing element 61.

The light in the object arm passes through a similar combination of optical elements as in the reference arm to ensure minimal differential dispersion. The main difference is that AOM elements 23′ and 24′ are modulated at a single frequency only and there is no multiple phase element between the two lenses 26′. After the AOM 24′, a mirror 52 (this can be eliminated, drawn here to compact the sketch) is used to divert light towards a beam splitter 65, that directs part of the light onto an XY scanning mirror pair 67 and interface optics, shown as a lens 68, that focuses light on the object to be imaged, 69. The reflected light from the object 69 goes back through the interface optics 68, is then de-scanned by the XY mirror pair 67 and launched into the fiber input of the 2^{nd} splitter, 8, by the focusing element 61′. Fiber polarization controllers, 62b and 62b′ are used to match the polarization in the two fiber arms of the fiber splitter 8, where interference takes place. A quarter wave plate, 51, in the main object arm, is oriented at 45 degrees with respect to the orientation of fast axis of linear polarizer 27′ to produce circular polarized light being sent to the object 69. Axial scanning is achieved by altering the main optical path difference, by moving the translation stage 81, carrying the lens 61 and reference fiber input of splitter 8.

The AOM elements 23 and 23′ are driven by drivers 64a and 64a′ respectively, and AOM elements 24 and 24′ by drivers 64b and 64b′. Drivers 64a′ and 64b′ are single frequency, while drivers 64a and 64b are multiple frequency. If the AOMs are used as Bragg cells, either in bulk or in fiber, they operate as frequency shifters, at typical frequencies F=40, 80, 160, 330 MHz while other values are equally possible.

The heterodyne photodected signal pulsates at a frequency ν determined by the frequency of signals applied to respectively 23, 24 23′ and 24′:

ν=|F₂₃+F₂₄−F_{23′}−F_{24′}| (1)

Depending on the bandwidth of the measurement signal, in case the interferometer in FIG. 3a is used in sensing, or depending on the image bandwidth, in case the interferometer is used in OCT imaging, the interference frequency shift ν needs to be larger than the sensing or image bandwidth respectively. For instance, for applications in sensing, ν, could be kHz or tens of kHz. For fast OCT imaging, the imaging bandwidth may exceed 100 kHz, in which case ν has to be larger than a few hundreds of kHz. A typical example is F_{23′}=F_{24′}=80 MHz where F_{23′}+F_{24′}=f_{O} defines the shift in frequency of the object signal, whilst F₂₃=F₂₄=fₚ=81, 82, 83, 84, 85, 86, 87 and 88 MHz. These give P=8 values for νₚ=|2fₚ−f_{O}|=2, 4, 6, 8, 10, 12, 14, 16 MHz and δν=2 MHz for the increment in frequency from one channel to the next. It should be obvious for those skilled in the art that the increment from one channel to the next does not need to be equal and any set of P different frequencies may be applied. An equal increment δν presents the advantage in an easy demodulation procedure using mixers where multiple harmonics can be created and used. However, for reducing the crosstalk between channels, it is better to have non multiple frequency values and non uniform spacing between successive frequencies.

It is equally possible to use any of the frequency shifter to shift the frequency up, while the other frequency shifters shift the frequency down. This may be desirable in those circumstances where a large carrier frequency of the photodetected signal is required, such as hundreds of MHz to 1 GHz. AOM frequency shifters operating at over 300 MHz already exist. For the example considered above, the signal at the output of 9 pulsates at a frequency:

νₚ=pδν, p=1 to 8, δν=2 MHz (2a,b,c)

When P=2 phase elements are used in 25a, as presented above in relation to FIG. 2a, the embodiment allows measurement of the amplitudes of interference that arise from vertically and horizontally oriented polarized light in two separate channels, V and H respectively. With two phase elements, only two RF signals are required as output from 64a and 64b, driving both AOM 23 and 24. If the frequency of the signal driving the two AOM 23′ and 24′ is F_{O}, then the two polarization channels are encoded on two different carrier radio frequencies, f_{1,2}=|F₂₃+F₂₄−2F_{O}| and deliver intensities Iᵥ and I_{H}. As described by M. Hee et al in the article “Polarization-Sensitive Low-Coherence Reflectometer for Birefringence Characterization and Ranging” published in J Opt Soc Am B 9, 903-908 (1992), considering the object 69 similar to a uniaxial crystal, having separate information of the interference arising from horizontal polarization I_{H} and from vertical polarization I_{V}, allows to calculate the polarization rotation in the object 69. This is obtained as a function of depth

φ(z)=ac tan(\sqrt{I_{V}(z)/I_{H}(z)}), (3a)

The reflectivity:

R(z)˜I_{V}(z)+I_{H}(z), (3b)

can also be calculated and represents a polarization insensitive measurement. The optical axis orientation θ could be obtained by using the formula

θ=(180°−ΔΦ)/2 (3c)

where ΔΦ is the phase difference between the two channels, I_{H} and I_{V}. In sensing applications, the transversal scanner 67 is not necessary. For OCT imaging, the polarization information as described above is obtained for each pixel in transversal section as targeted by the object beam orientation, controlled by deflection in the XY scanner 67. If two phase elements only are used in 25, then, en-face OCT images are obtained: an image for birefringence, a polarization insensitive image, and eventually an en-face image with the axis orientation. When both scanners in the XY scanner 67 are used, en-face OCT images from different depths, controlled by the translation stage, 81, are generated, with polarization information. B-scan images can also be generated by using one scanner in the pair 67 at a fast line rate and the translation stage 81. Typical scanning speeds in en-face generation are obtained by driving the line scanner in the pair 67 at 500 Hz and the frame scanner in the pair 67 at 2 Hz. With 8 signals driving 23 and 24, 8 en-face OCT images with different polarization states from the same depth, controlled by translation stage 81, are obtained, simultaneously, in the time of 0.5 s required to generate a single en-face image.

As all frequencies vₚ are present at the same time at the output of 9, a decoder, 91, is used to separate the signals in the P channels. The decoder 91 can be assembled using several band pass filters tuned on frequencies vₚ. Alternatively, for each channel, a mixer can be used followed by a low pass filter, mixing the output signal from 9 with a signal of frequency pδν, derived from the drivers 64a, 64b, 64a′ and 64b′, using means known in the art of producing a mixed signal. As another alternative, a digitizer can be used to separately process signals in the imaging bandwidth around carriers vₚ, store data and allow visualization of any of the chosen channel or combination of channels later on.

FIG. 3b depicts a 2^{nd} embodiment of the apparatus according to the invention that can supply information from several different depths, zₚ, simultaneously. To achieve such a functionality, the system described in FIG. 3a is modified by: (i) Eliminating the requirement to have two linear polarizers 27 and 27′; (ii) In the multiplexer 2b, the multiple polarisation element 25a is replaced by a multiple delay element 25b which generates stepped delays, dₚ, for optical rays at different transversal incident positions on it, usually a stair for each diffracted first order diffracted beam in the fan of beams created by the AOM 23, driven by as many RF signals of different frequencies as the number P of stairs in 25b. For simplicity, let us consider that the stepped delays vary by an increment δ. The last modification consists in (iii) removal of the quarter wave plate 51. Such an embodiment allows recording the amplitudes of interference that arise from different optical depths in the object 69 in separate channels, each channel encoded on a different carrier radio frequency. In the object arm, a block 2b′ is used with no element between the lenses 26′. When an XY scanner 67 is used, en-face OCT images from different depths, zₚ, are generated with depths determined by the stair delays in 25b. Let us say that δ=20 μm. With 8 signals driving 23 and 24, en-face OCT images from 8 depths, separated by δ, are obtained simultaneously in the time required to generate an en-face OCT image (0.5 s using the example above of 500 Hz line rate and 2 Hz frame rate). The embodiment in FIG. 3b covers the axial range of Pδ=160 μm, collecting simultaneously 8 images separated by δ=20 μm. Jumping the translation stage 81 by Pδ and repeating the acquisition, 8 more images can be acquired and so on.

B-scan images can also be acquired using the translation stage 81 and one scanner only in the pair 67. The range covered by the translation stage D and the differential step 8 need to be correlated. Let us say that the translation stage 81 can be used to cover an axial range of D=1 mm In this case, δ is adjusted to be equal to D and P=8 B-scan images are generated, one from Z to Z+D, 2^{nd} from Z+D to Z 30 2D, and so on up to P=8, covering in total an axial range Z to 8D in the same time as it would be taken by the conventional OCT method to create a B-scan of axial range D only.

### Sequential Operation

In the operation of embodiments in FIGS. 3a and 3b above, simultaneous application of a number P of RF signals was used to the pair of AOMs 23 and 24. This ensures that all P channels are present simultaneously in the photodetected signal delivered by the balance detection receiver 9. Another possibility is to sequentially apply each RF signal out of the P possibilities, once at a time, switching the channels on and off with a toggle generator 78, shown in dashed line. In FIG. 3a, this procedure leads to sequential acquisition of polarization information and in FIG. 3b to sequential acquisition of depth information.

Applying only one RF signal to the AOM23 and 24 has the advantage of optical power distributed into a single channel only at a time. No cross talk between channels exists either.

It may also be found advantageous to work with a set of 4 channels sequentially switched to the next set of 4 channels for a total of P=8, or to switch 4 times, 2 channels, to the next 2 channels and so on.

The optimum number of simultaneous channels should be chosen depending on the available reference power. As shown in the papers: “Limitation of the achievable signal to noise ratio in OCT due to mismatch of the balanced receiver”, by C. C. Rosa, A. Podoleanu, published in Applied Optics, 43 (25): 4802-4815, 2004 and Unbalanced versus balanced operation in an OCT system, by A. Gh. Podoleanu, published in Appl. Opt., 2000, Vol. 39, No. 1, pp. 173-182, there is an optimum attenuation for the reference power needed to reduce the excess photon noise and maximize the signal to noise ratio. The power per channel in the reference path scales down with the number of parallel channels P, by P². When the reference power is so high, that in order to reduce the excess photon noise, it needs to be attenuated by more than 64 times, there is room for P=8 channels. However, if the reference is sufficient to be attenuated by only 4 times to reduce the excess photon noise, then only P=2 channels simultaneously could be used without penalty in the signal to noise ratio due to decrease in the interference signal strength as result of lowering the reference power. Therefore, there is an optimum trade-off in terms of the P number of simultaneous channels and signal to noise ratio.

To adjust the reference power, the coupling efficiency of splitter 7 can be reduced towards the object arm. Maintaining the same safety level on the object 69, the optical power emitted by the optical source block 1 can be increased while the coupling efficiency towards the object arm is reduced correspondingly. In this way, power can be increased to be launched towards the reference path to compensate for the division of optical power in 23.

Sequential switching of the RF signals brings the disadvantage of enlarging the bandwidth of the signal per each channel. For instance, let us say that the en-face imaging takes place at 2 ms per T-scan line rate, with 200 pixels, this gives 10 μs per pixel. A sequential switch of P=5 channels requires 2 μs per each channel. This means that each channel is chopped on and off at a frequency of 100 kHz, with a delay of 2 μs between adjacent channels, and each channel is kept on for a 1/P=0.2 fraction of the time per each pixel. This reduces the strength of the signal per each channel by the same factor, but has the advantage of total elimination of cross talk.

In this way, a separate en-face OCT frame can be collected for each RF pair of frequencies applied to AOMs 23 and 24, taking advantage of full reference power per channel with the disadvantage of slowing down the acquisition.

The sequential procedure achieves an elegant solution of sequential electronic switching of polarization channels in FIG. 3a and of depth channels in FIG. 3b.

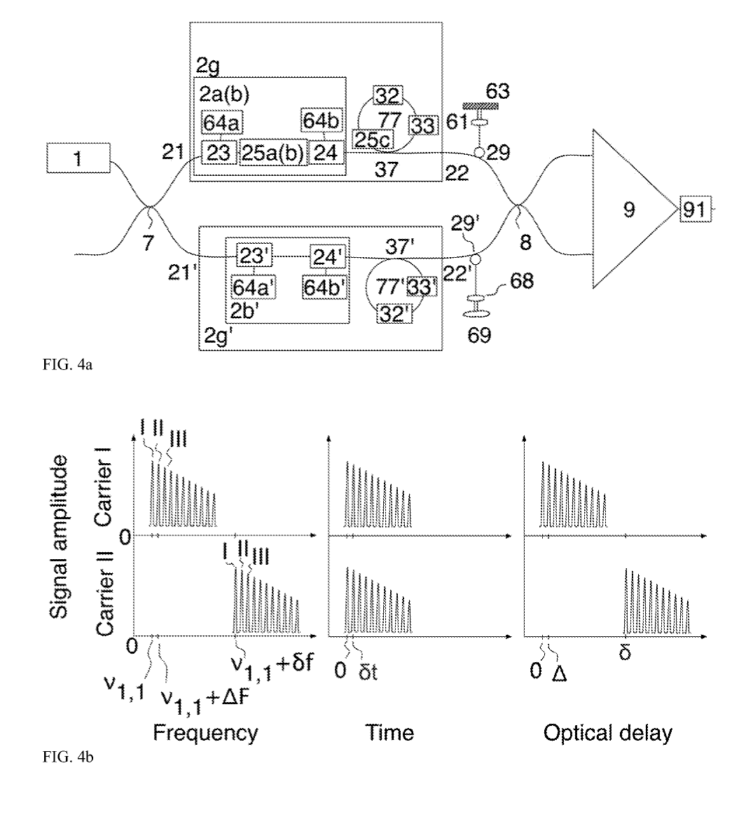

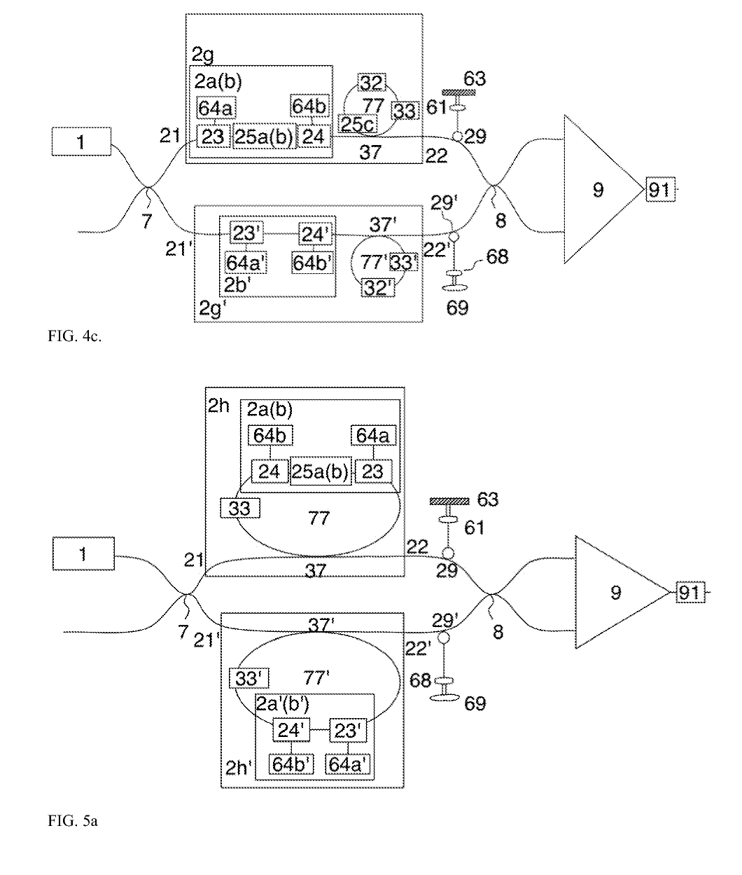

FIG. 4a presents a third embodiment of the apparatus according to the invention, where a combination of two multiplexers as disclosed in FIG. 2g are used, consisting of a combination of two different categories of phase elements. Let us say that the ring in the reference arm, 77, is of length L_{R} and the ring in the object arm, 77′, is of length L_{O} and the frequency of signals driving the two frequency shifters 32 and 32′ is F_{R} and F_{O} respectively, and where |F_{R}−F_{O}|=ΔF. The signal at the output of balanced receiver 9 pulsates at a frequency:

ν_{p,m}=(2fₚ−fₒ)+mΔF. (4a)

For p=1, the frequencies of the driving signals can be adjusted to make 2f₁−fₒ=0 and for the next values p, the fₚ₊₁−fₚ=δf. (4a) becomes:

ν_{p,m}=(p−1)δf+mΔF (4b)

The frequencies encode signals from depths:

z_{p,m}=|pδ+m(L_{O}−L_{R})| (4c)

The multiple channels produced by such a combination of delaying elements is illustrated in FIG. 4b for P=2 and M=11. The multiple recirculation loops generate more channels than 10, but only the first 11 are shown, as higher order channels exhibit smaller strength due to their roundtrip attenuation. The parallel channels multiple delays ensure similar strength among the pair of channels denoted with Roman numerals, while the recirculation loops exhibit 4-6 dB decay from one roundtrip to the next (from the set I to the set II, from the set II to set III and so on). For example, let us consider a frequency difference ΔF=1 MHz due to interference of waves traveling through the rings only and that the AOM 23 and 24 and 23′ and 24′ are driven as such as 2f₁−fₒ=0 while for the next channel in 25b, δf=40 MHz due to interference between the waves traveling through 25b and the main object arm. In this case, the signal in the first channel pulsates at ν_{1,1}=ΔF=10 MHz and in the second channel at ν_{2,1}=ΔF+δf=50 MHz. On the left, FIG. 4b lists the frequencies of the PM=20 channels. Signals of frequencies v_{1,1} and v_{2,1}=v_{1,1}+δf exhibit similar strength. Similarly, signals of frequencies v_{1,m}=v_{1,1}+mΔF and ν_{2,m}=ν_{1,m}+δf also exhibit similar strength, where m=1 to M=10, ie for any given m, channels irrespective of p=1 or p=2 are of similar strength. The Roman numerals above the carriers in FIG. 4b, denote the number of recirculations, m. Recirculations marked with I in both sets of channels exhibit the same strength imprinted by the AOM 23 and 24 while from the set of I to the set of II recirculations, attenuation will be incurred as created by ring recirculators 77 and 77′.

The figures in the middle of FIG. 4b show the arrival times of wave trains measured from the arrival of the first wave train of signals corresponding to different p phases imprinted by the multiple phase element 25 (adjusted to determine either differential delays, 25b, or polarizations, 25a). For instance, for a delay δ=1 cm created by the phase element 25b placed in the multiplexer 2b, and for a differential delay Δ=10 μm between the recirculation loops 77 and 77′, then M=11 OPD values of mΔ, with m=1 to 10 will be interrogated for p=1 and M=11 OPD values of δ+mΔ will be interrogated for p=P=2 for a total of PM=22 delays.

Alternatively, if the multiple phase element 25b is replaced with a polarization phase element 25a, creating two orthogonal polarisations, then the two signals I of frequencies ν_{1,1} and ν_{2,1} will give a polarization sensitive signal (image) at Δ, the two signals II will give a polarization sensitive signal (image) at 2Δ and so on. Polarization collection means in fact at least two pieces of information, in channels H and V, that can be put together to infer a polariation insensitive measurement of reflectivity (or image) and a birefringence signal (image). If phase control is stable between the two orthogonal polarizations, then a 3^{rd} image can be produced, delivering the orientation of the birefringence axis in the object 69, as described above in connection with the embodiment in FIG. 3a, at each multiple depth Δ.

FIG. 4c shows in diagrammatic form, another version of the third embodiment of the apparatus according to the invention. This is similar to that in FIG. 4a, but here the splitter 29′ is moved into the recirculating delay, ring 77′, ie the path up to a depth inside the object 69 is now part of the secondary loop path. Out of the multiple depths in the object 69, only one depth is selected by moving the mirror 63 axially in the main path of the interferometer.

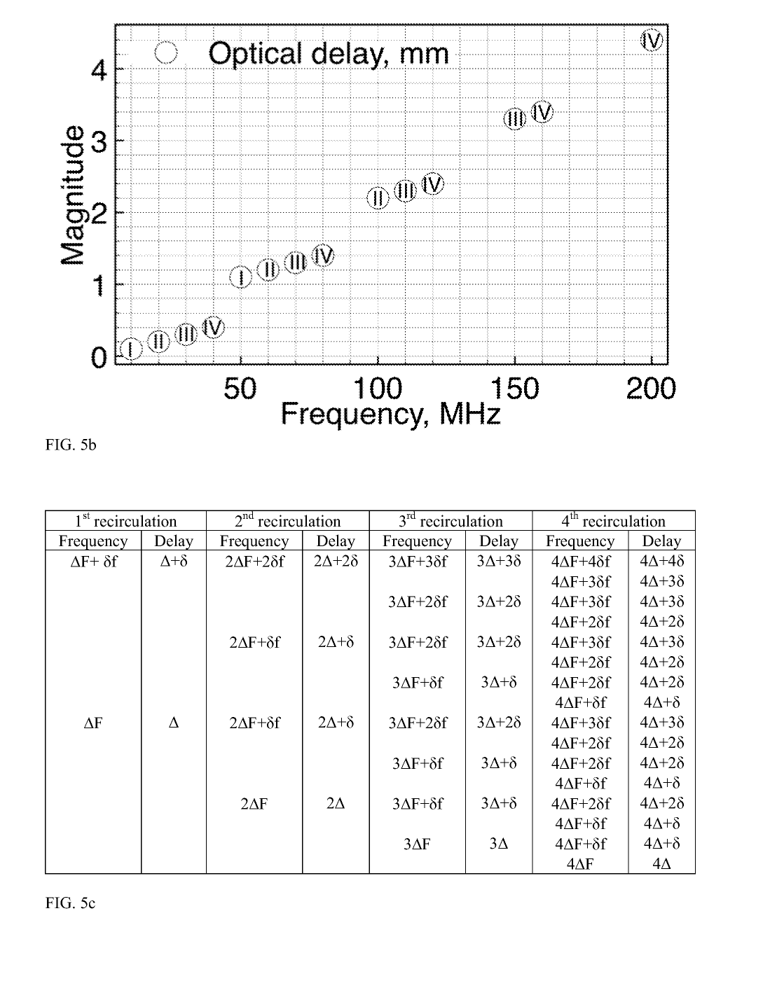

A fourth embodiment according to the invention is disclosed in FIG. 5a, where a multiplexer 2h is placed in the reference path, containing multiple parallel shift delays, in the multiple phase element 2b, that are introduced within a recirculation loop. A similar recirculation loop is replicated in the object arm. The frequency shifters 32 and 32′ can be eliminated in this embodiment but amplifiers 33 and 33′ may still be used. The lengths of the two rings 77 and 77′ are respectively L_{R} and L_{O}, where L_{R} is measured along the minimum delay channel in the phase elements array 25.

The frequencies of the signals applied to the two AOMs in the parallel paths are fₚ. In the block 2h′, two AOM 23′ and 24′ are shown, to compensate for dispersion of the two AOMs 23 and 24 in the multiplexer 2h. However, a single frequency shifter of total length to that of the AOMs in the reference arm can be used instead. Therefore, for simplicity, we will consider the effect of the two AOMs 23′ and 24′ as resulting from a single, third frequency shifter in the embodiment in FIG. 5a, and the frequency of the signal applied to it is f_{O}. Considering in general P parallel paths, for M round-trips, the photodetector outputs cumulates interference signals pulsating at frequencies belonging to a set of r values from 1 to R, where:

$$R = P \frac{( 1 - {P}^{M} )}{( 1 - P )} \qquad ( 5 a )$$

frequencies determined by:

ν_{P,r}^{(m)}=Σᵢ₌₁^{P}s_{i,r}(2fₚ−f₀) (5b)

where

Σᵢ₌₀^{P}s_{i,r}=m (5c)

For P=2, M=1, the two coefficients s_{i,r,} are (1,0), (0,1) which determine two distinct frequencies. For P=2, M=2, the two coefficients s_{i,r,} are (2,0), (1,1) and (0.2), which determine 3 more distinct frequencies. For P=2, M=3, the two coefficients s_{i,r} are (3,0), (2,1), (1,2), (0,3) which determine 4 more distinct frequencies. In total, 2+3+4=9 distinct frequencies out of 14 components. For P=2, M=4 the two coefficients s_{i,r} are (4,0), (3,1), (2,2), (1,3), (0,4) which determine 5 more distinct frequencies. In total, for P=2 and M=4, there are 2+3+4+5=14 distinct frequencies.

As another example, for P=3, M=1, the three coefficients s_{i,r} are (1,0,0), (0,1,0) and (0,0,1), which determine 3 distinct frequencies. For P=3, M=2, the three coefficients s_{i,}_{r are (}2,0,0), (0,2,0), (0,0,2), (1,1,0), (0,1,1) and (0,1,1) which determine 6 more distinct frequencies. For P=3, M=3, the three coefficients s_{i,r} are (3,0,0), (2,1,0), (2,0,1), (1,2,0), (1,0,2), (1,2,0), (0,1,2), (0,2,1), (0,0,3), (0,3,0), (1,1,1), which determine 10 more distinct frequencies In total, 3+6+10=19 distinct frequencies out of 39 components.

For instance for only two phase elements in 25, P=2, the frequencies generated can be expressed as:

ν_{2,r}^{(m)}=Σᵣ₌₀^{m}└(m−r)(2f₁−f_{O})+r(2f₂−f_{O})┘ (5d)

For the first roundtrip, m=M=1, for r=0 gives ν_{2,1}⁽¹⁾=(2f₁−fₒ) and for r=1 gives ν_{2,2}⁽¹⁾=(2f₂−f_{O}), i.e. P=2 distinct frequencies. For the second pass, M=2, there are 4 more components: ν_{2,1}⁽²⁾=2(2f₁−f_{O}), ν_{2,4}⁽²⁾=2(2f₂−f_{O}) and two components of νhd 2,2⁽²⁾=ν_{2,3}⁽²⁾=(2f₁−f_{O})+(2f₂−f_{O}) i.e. three more distinct frequencies. For the third pass, M=3, there are 8 components: ν_{2,1}⁽³⁾=3(2f₁−f_{O}), ν_{2,8}⁽³⁾=3(2f₂−f_{O}), three components ν_{2,2}⁽³⁾=ν_{2,3}⁽³⁾=ν_{2,4}⁽³⁾=2(2f₁−f_{O})+(2f₁−f_{O}), and three more components ν_{2,5}⁽³⁾=ν_{2,6}⁽³⁾=ν_{2,7}⁽³⁾=(2f₁−f_{O})+2(2f₁−f_{O}) i.e. 4 more distinct frequencies only. For a total of M=3, there are 2+4+8=14 components but only 9 distinct frequencies.

Let us consider that the difference of frequency between the excitation of AOMs in the parallel paths in the two arms is δf=40 MHz. Let us also consider 2f₁−f_{O}=10 MHz=ΔF through the element 25 of minimum delay and 2f₂−f_{O}=2f₁f_{O}+δf=ΔF+δF, through a δ delay along the second path in 25b. Let us consider the first channel due to the first circulation in the rings at ν_{2,1}⁽¹⁾=10 MHz and the second channel due to the circulation through the other parallel path, at ν_{2,2}⁽¹⁾=2f₁−f_{O}+δf=50 MHz. Also, let us assume an optical path difference between the rings of |L_{R}−L_{O}|=Δ=0.1 mm and the optical delay introduced by a single stair 25 is δ=1 mm The 14 distinct frequencies select signal from 14 depths. Due to the first round-trip, for m=1, two depths are selected: Δ and Δ+δ, for the second round-trip, for m=2, 2Δ, 2(Δ+δ) and 2Δ+δ, for the 3^{rd} round, m=3, 3Δ, 3Δ+δ, 3Δ+2δ, 3Δ+3δ and for a fourth round, m=4, 4Δ, 4Δ+δ, 4Δ+267 , 4Δ+3δ and 4Δ+4δ.

The depths selected from the object correspond to the following optical path differences: mΔ, m(Δ+δ), rΔ+(m−r)(Δ+δ), with m=1 to 4 and r=1 to 4. These can be expressed as:

z_{2,r}^{(m)}=s₁d₁+s₂d₂ (5e)

where for m=1, (1,0), (0,1). For m=2, (2,0), (1,10), (0,2). For m=3, (3,0), (2,1), (1,2), (0,3). For m=4, (4,0), (3,1), (2,2), (1,3), (0,4) These determine 14 distinct OPD values, i.e. selecting 14 distinct axial positions in the object from d₁=Δ=0.1 mm to 4d₂=3(Δ+δ)=4.4 mm with 12 intermediate steps.

These combinations are illustrated in FIG. 5b and FIG. 5c for M=4 and P=2. The net advantage of such a configuration is that more than PM channels are created, ie instead of adding only one more channel for each recirculation in the rings 77 and 77′, 2 unique delays are produced in the first I recirculation, 3 additional unique delays in the II recirculation, 4 additional unique delays in the third recirculation, III, and 5 additional unique delays in the fourth recirculation, IV, ie for each recirculation, m=1 to 4, m+1 extra distinct channels are added. Every recirculation creates not only unique frequencies, but some frequencies that were pre-existing in previous circulations. However the unique OPD associated to each frequency remains the same irrespective of the combination of delays.

FIG. 5d shows in diagrammatic form, another version of the fourth embodiment of the apparatus according to the invention. This is similar to that in FIG. 5a, but here the splitter 29′ is moved into the recirculating delay, ring 77′, ie the path up to a depth inside the object 69 is now part of the secondary loop path. Out of the multiple depths in the object 69, only one depth is selected by moving the mirror 63 axially in the main path of the interferometer.

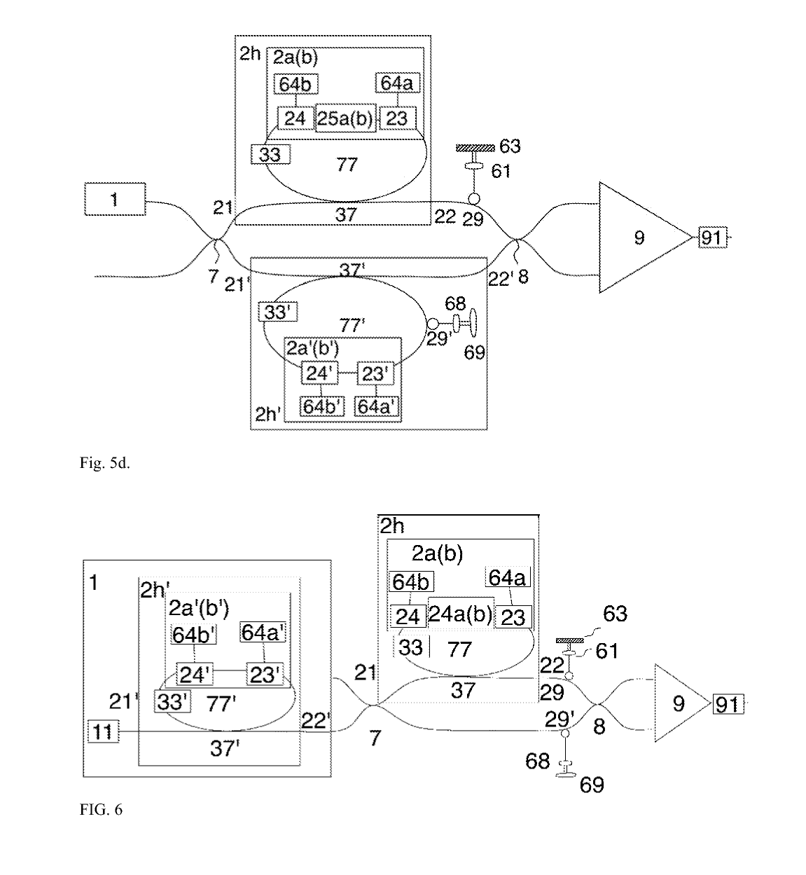

FIG. 6 shows another embodiment of the invention, where multiple paths are placed within the optical source, 1. The multiplexer is placed in the reference path, where a ring 77 is used, of optical path length D_{R}. The optical source block, 1, consists in a ring 77′, of roundtrip length D_{S} and a broadband light source, 11. Light from the optical source 11, after being recirculated in the ring 77′, contributes to a useful photodetected signal for optical path difference (OPD) values measured in the main interferometer, given by:

OPD+mΔ=0, where |D_{R}−D_{S}|=Δ (6a,b)

Some of the light, travelling both multiple source paths and multiple reference paths, of lengths: m(D_{R}+D_{S}) is lost, as such lengths are much longer than the main object path. Although power goes into multiple paths outside coherence, this is not essential as long as the power to the object 69 is sufficiently strong, up to the safety level. This means that the losses in the object arm are eliminated as an improvement to the embodiments in the application US2011/0109911. As a second advantage, both the reference and object arms share the same noise source.

If power to the object 69 is not limited by safety, then the present embodiment exhibits less noise for the same achievable signal from a given depth.

An alternative is to use a powerful optical amplifier 33′, in which case source 11 is not necessary.

Optical source 11 can also be narrowband and tunable (swept source), in which case the embodiments in FIGS. 3a, 3b, 4a, 4c, 5a, 5d and 6 presented so far can operate in spectral domain OCT.

As another alternative for spectral OCT, the photodetector unit 9, this can use a spectrometer, or two spectrometers in balanced detection, driven by the second splitter 8, as described in “Fourier domain optical coherence tomography system with balance detection”, by A. Bradu and A. Gh. Podoleanu, published in Opt. Express, 2012, 30 Jul. 2012, Vol. 20, No. 16, 17522-17538. In this case, the optical source is broadband.

### Mirror Terms Elimination

The frequency shifters, used throughout the invention, in different embodiments, can advantageously be used to eliminate the mirror terms when the optical source 1 is a tunable source and the embodiments operate in spectral domain OCT.

### Swept Source Interrogation

Frequency shifting in the embodiments above can be combined with principles of swept source OCT. Let us say that in the embodiments above, subject so far to broadband illumination, Δλ, data is provided in large steps, d (determined for instance by large delays in 25a), much larger than the coherence length, l_{c} (determined by λ²/Δλ). Then, if the source 1 is changed to a swept source of line-width δλ, sufficiently small to determine a swept source interferometry depth range of at least d/2. A-scans can be assembled for axial range intervals between positions separated by d. With a tuning bandwidth Δλ in the range of tens of nm, for a central wavelength of microns or submicrons, δλ should be a fraction of a nm. By sweeping the optical frequency of the source, signals at the carrier frequencies νₘ are generated, deviated to lower or higher values depending on the OPD value and its sign. All these carrier frequencies are present in the photodetected signal output of 9. Each resulting channel signal represents a swept source interference signal. FFT of the resulting signals, according to means known in the art, leads to an A-scan in each channel. These A-scans can be used to extend the axial distance for as long as the coherence length of the sweeping source is either side of the OPD=md values. An example of such interrogation in a multiple path interferometry configuration was communicated in the paper “Extra long imaging range swept source optical coherence tomography using re-circulation loops”, published in Opt. Express 18, 25361-25370 (2010), by A. Bradu, L. Neagu, A. Podoleanu.

Further advantage to the prior art, obtained by driving the embodiments presented with a swept source is obtained in ensuring a constant sensitivity with axial depth in swept ource (SS)-OCT. By using P=2 signals only in FIG. 3b, and correlation of frequency difference between the channels with 8, as explained in the paper immediately above in Optics Express, the mirror term of the second channel can be superposed with the frequency term for the 1^{st} channel The decay of sensitivity of the 1^{st} channel is compensated by the mirror term due to the 2^{nd} channel In this way, constant sensitivity with depth in SS-OCT can be obtained. The adjustment conditions to achieve this is demonstrated below. In general, in SS-OCT, for a given OPD in the main loop of the interferometer, the frequency components in the photodetected signal are given by:

$$f = \frac{Δ k}{2 π} γ \cdot OPD \qquad ( 7 )$$

where Δk is the tuning bandwidth in wave-number and γ is the scanning rate in Hz. The coefficient C is determined by the swept source, i.e. by its scanning speed and tuning bandwidth. The larger the tuning bandwidth, Δk and the scanning speed, γ, the larger the frequency f generated, i.e. the number of cycles in the photo-detected signal for a given OPD value. Let us consider only two carrier frequencies, ν₁ and ν₂, applied to the embodiment in FIG. 3b, having an element 25b of two delays, zero and δ. If frequency shifting is used at ν₁, then two frequency components are created:

$$f = {v}_{1} + \frac{Δ k}{2 π} γ \cdot OPD , f = {v}_{1} - \frac{Δ k}{2 π} γ \cdot OPD \qquad ( 8 a \text{,} b )$$

where the second frequency creates what is called a mirror image.

The second channel is created by a carrier ν₂ created in a multiplexer 2b by traversing a large delay, δ, leading to frequencies:

$$f = {v}_{2} + \frac{Δ k}{2 π} γ \cdot ( δ - OPD ) , f = {v}_{2} - \frac{Δ k}{2 π} γ \cdot ( δ + OPD ) \qquad ( 9 a \text{,} b )$$

When OPD increases, it can be noticed that frequency given by (8a) increases as well as the mirror frequency (9b). However, the strength of the first diminishes, while the strength of the second enhances, as for the first the OPD becomes larger while for the second, δ-OPD becomes smaller. Therefore, the variation of intensity with OPD can be eliminated by putting together the two signals. This becomes possible if:

$${v}_{1} = \frac{Δ k}{2 π} γ \cdot OPD = {v}_{2} - \frac{Δ k}{2 π} γ \cdot ( δ - OPD ) \qquad ( 10 )$$

which leads to:

$$\frac{Δ k}{2 π} γ \cdot δ = {v}_{2} - {v}_{1} \qquad ( 11 )$$

where

$$\frac{Δ k}{2 π} γ = G$$

defines the scanning rate of the swept source (Hz/mm) Equation (11) shows that if the difference of the two carrier frequencies is matched to the delay δ, then SS-OCT investigation is possible with constant sensitivity. A similar principle of operation can be implemented here using the frequency shifting in the other embodiments, in FIGS. 3a, 4a, 4c, 5a, 5d and 6. More carriers can be added to extend the axial range, by superposing the frequency due to the second carrier with the mirror frequency due to the 3^{rd} carrier and so on.

The same type of adjustment is also possible when using spectrometers in 9, and using a broadband source 1.

### Despeckle

The embodiments above can be used for despeckle. The multiple phase elements in 25a can be adjusted to produce fractions of 2π differences, while each exhibits the same length. The decoder 91 provides a number of P signals, slightly shifted in phase. After rectification, they can be all superposed to wash out the speckle.

### Structured Light

In microscopy, improvement of transversal resolution is achieved by illuminating the target with different phase shifted grids. Such a principle is explained in the article “Method of obtaining optical sectioning by using structured light in a conventional microscope”, by M. A. A. Neil, R. Ju\check{}skaitis, and T. Wilson, published in Optics Letters, Vol 22., pp, 1905-1907, (1997). Such grids are created using patterns or diffraction gratings. The procedure requires shifting the grid laterally or rotation of the grid. By doing so, the resolutions along lateral and axial directions improve by a factor of 2. Alternatively, if interference is used, no such physical grid is necessary. If scanning is employed, by switching the reference beam off and on, an equivalent grid is created, as described in “Structured interference optical coherence tomography” by Ji Yi, Qing Wei, Hao F Zhang, and Vadim Backman published in Optics Letters, 37/15, 2048 3050, 2012. In this paper, spectral OCT was used, and each B-scan was composed of 256 A lines, with a B-scan rate of 10 frames/s. For a 250 μm scanning range, each A-scan occupied a 1 μm. Let us say that the transversal resolution in the image is 9 μm. Let us establish a grid of periodicity close to this value, of 12 μm. In this case, 250/12˜21=N bars over the image will be created. By making the number N non integer, the grid varies over the image and the desired phase change is obtained automatically, as described in the paper by M. A. A. Neil above. The disadvantage of the method is that requires collection of at least 3 frames. Leaving the variation of the grid non synchronous with the transversal scanning, requires collection of more than 3 frames. In the paper by Yi, 10 frames were collected. This takes time. The embodiment in FIG. 3a can eliminate this waste of time and collect all 3 or 10 phases at the same time. To configure the embodiment in FIG. 3a for structured light, the toggle generator 78 is synchronised with the driver of the lateral scanner 67.

### Structured Light OCT Cross-Section (B-Scan) Imaging

The optical source 1 is swept source, or is broadband and the photodetector unit 9 is replaced with a spectrometer. Let is say that according to the theory, 3 frames are needed of spectral OCT images, at 2π/3 phase interval apart. In this case, the two drivers 64a and 64b are driven with P=3 signals of different frequency and the embodiment in FIG. 3 (3a or 3b) operates with 3 channels. Each RF signal, for p=1 to 3 is switched on and off by 78, at a frequency F_{on/off}=N×lateral scanning rate. With the example above, if the lateral scanning is performed at 10 Hz, the frequency of the switch on and off is ˜F_{on/off}=210 Hz. The three signals are shifted in phase by 2π/3 in relation to each other, ie by ⅓ of the period of the signal of 210 Hz. Equivalently, the toggle on off generator 78 is made of P=3 generators, each shifted in phase by ⅓ of the period of the signal applied. Several formulae can be used to infer the final image, I, using the phases applied and the number of shifts, a possible equation to remove the grid is:

$$I = \sqrt{{\sum }_{{p , m = 1}_{p \neq m}}^{P} {( {I}_{p} - {I}_{m} )}^{2}} ,$$

where Iₚ are the images collected for a phase step in 25a. Other formulae may be used as explained in the theory of structured light microscopy, based on a sequence of Fourier transformations. In general, more channels can be used, in which case, for P channels, P signals are applied to the AOMs 23 and 24 at different excitation frequencies (40, 80 MHz, etc). They are all switched on and off at the same frequency F_{on/off} as above (210 Hz), but at different moments within the 1/F_{on/off} period, shifted in phase between a channel to the next by 1/(P F_{on/off}). These signals switch the P signals driven by drivers 64a and 64b on and off. All P signals output by 64a and 64b are toggled on and off at the same frequency, F_{on/off} but with a phase difference for each channel to create a shifted grid in the final image. Several such grids, for different phases are photodetected simultaneously and processed by 91. Combining them according to principles of structured light microscopy leads to improvement of the transversal resolution along the lateral coordinate in the image by a factor of up to 2.

### Structured Light En-Face (C-Scan) Imaging

In this case the optical source 1 is broadband. Both laterals scanners in 67 are driven for instance the line scanner with a 500 Hz ramp and the frame scanner with a 2 Hz ramp. Using the same N=21 as in the example above, F_{on/off}˜10.5 kHz.

Further functionality is achievable in this regime, by taking advantage of the two scanners in 67. Normally, in structured light illumination, the grid is rotated in order to improve the resolution along similar direction in transversal section. As the grid is here created in the interference signals, two possibilities are proposed in this disclosure.

(i) Utilization of the two scanners in 67 to create fast line scans oriented at different angles than in a simple raster operation. In a simplest and widely used raster scanning, a scanner is ran fast, at a line rate to provide the line in the raster and the other scanner is ran slow to provide the frame. In such conventional raster, the lines are oriented horizontally.

Here, both scanners are ran at similar speeds to create a raster where the lines in the raster are oriented parallel, but all at a different angle than the horizontal, angle depending on the control of the two scanners in the pair 67. In this way, in the same area of a conventional raster, the optical beam is deflected over directions different from the horizontal. The improvement in the lateral resolution will take place in the direction of the line. By changing the orientation of the lines in sequentially generated rasters, images are collected with improved resolution, using the reference beam being chopped on and off using the AOMs driven by 64 and 64b at F_{on/off}.

(ii) Utilisation of the sampling function created in en-face OCT, as presented in “Coherence Imaging by Use of a Newton Rings Sampling Function”, published by A. Gh. Podoleanu G. M. Dobre, D. J. Webb, D. A. Jackson, in Optics Letters, Vol. 21, pp. 1789-1791, (1996) and in “En-face Coherence Imaging Using Galvanometer Scanner Modulation” published by A. Gh. Podoleanu G. M. Dobre, D. A. Jackson in Opt. Letters, vol. 23, pp. 147-149, (1998). By shifting the incident beam away from the pivot of one or both galvanoscanner mirrors in the XY scanner 67, different periodicity of the sampling function can be achieved. The sampling function mentioned in these two articles, in the form of Newton rings and respectively grid of lines can be employed to take over the function of the grid projected over the target in conventional structured light microscopy. The orientation of such a grid in the final en-face OCT image changes depending on the orientation of the mirror used as target. The three phase shifts, as a minimum, necessary for structured light demodulation, require a change in phase in the reference path of ⅓ of wavelength. The multiple phase element 25b in the embodiment in FIG. 3b can be used to implement such small phases, to shift the fringe pattern and perform equivalent grid movement like in structured light. Once P=3 or more phase shifts are implemented in the embodiment in FIG. 3b, improvement of transversal resolution is achieved without needing to switch on and off the reference beams. The grid due to the sampling function can also be virtually rotated. In fact, inside a scattering volume object 69, it can be considered that scattering points are organised within equivalently oriented mirrors. Each such mirror, depending on its tilt, along the vertical and horizontal direction, will determine a rotated interference sampling function which can be used as the grid in the process of structured light demodulation. The maximum tilt of these virtual mirrors is determined by the coherence length, l_{c}, of the broadband optical source. For a coherence length l_{c}=20 microns, and for a central wavelength λ=0.8 microns, 40 dark bands can be obtained, as determined by the ratio l_{c}(λ/2). This corresponds to an image size of 20 pixels (according to the Nyquist theorem). By applying three delays, of 0, 2π/3 and 4π/3, the bands will move allowing sampling of the object structure in that plane, for all points within a coherence length. Alternatively, for better density of the grid, a combination of modulation imprinted by switching the reference beams for the P carriers on and off with the modulation imprinted by shifting the object beam away from the pivots of the galvoscanners 67, or with the Newton rings in case the object beam is incident on pivots.

Obviously, for switching off the P carriers, at least one of the carrier in the pairs of signals applied to the AOMs 23 and 24 can be used and not both.

### Frequency Shifting Outside the Multiple Delays

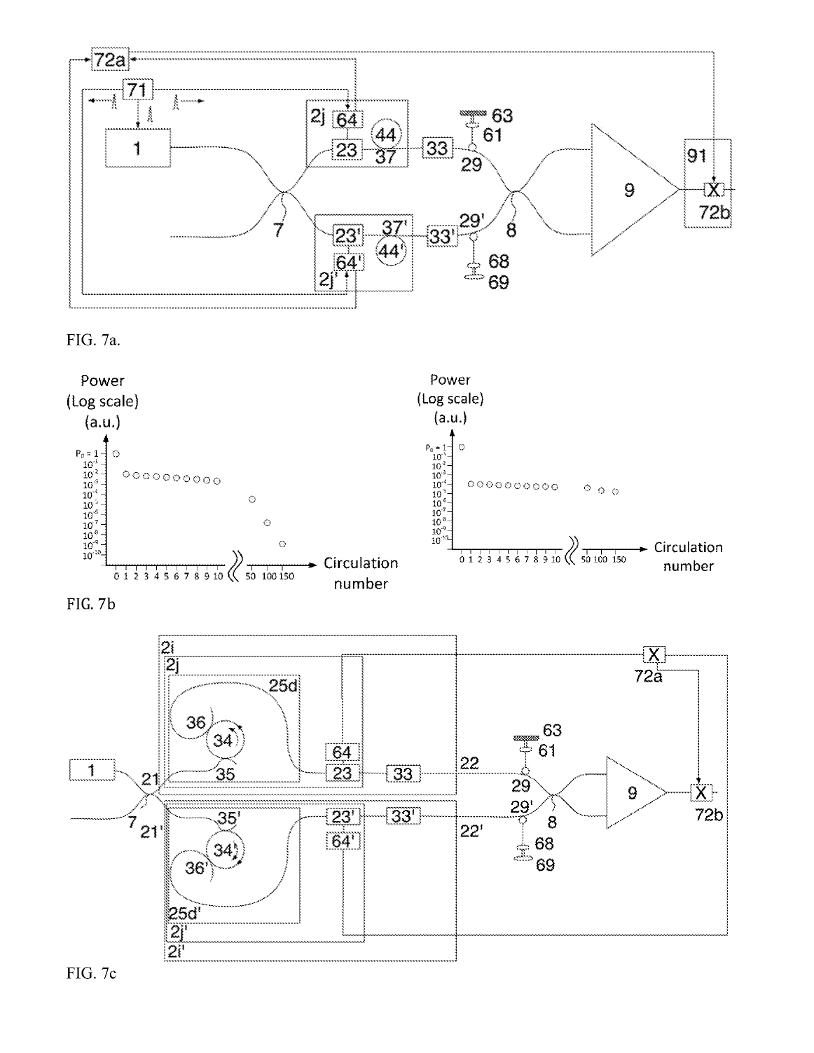

In the PCT application WO/2009/106884A1 and UKPO, 0803559.4, by Podoleanu, the depth was encoded on the frequency shift imprinted by the number of wave passages through frequency shifters. This limited the applicability of the configurations disclosed, as such modulators are dispersive, lossy, and therefore require optical amplification. Addition of extra components make the roundtrip length larger than 10 cm, ie small roundtrips are not possible. In the embodiment in FIG. 7a, the frequency shifters 23 and 23′ are placed outside the rings 44 and 44′. The rings now can be made more compact. The rings 44 and 44′ are connected to the main paths of the interferometer via couplers 37 and 37′ respectively. The optical source block 1 is pulsed, with a pulse-width τₛ which is less than the round trip time in the loops, τ.

In the reference path, a third splitter, 29, conveys light towards a reference mirror 63 used to adjust the OPD in the interferometer. This third splitter can be eliminated and have the reference path in transmission as in the embodiments in FIGS. 3a and 3b. In the object path, a fourth splitter in the form of a circulator, 29′, conveys light towards the object 69.

Interference will take place for OPD values satisfying equation, OPD+mA=0, where OPD is measured along the main paths of the interferometer, up to a mirror or the surface of the the object, 69, and Δ is the OPD between the lengths of the two rings 44 and 44′. If significant strength signal can be acquired for m=M roundtrips through the two rings 44 and 44′, then M depths can be interrogated in a time T=Mτ, covering an axial range L=MΔ. For instance, for M=100, with T=10 ns, T=1μs. The differential path length Δ, between the two rings can be adjusted from small values, let us say 10 μm, as required in OCT tissue measurements, up to 1 mm, as required in tracking the axial position of a reflector within a large range of 100 mm, or for optical time domain (OTDR) applications. In these examples, the bandwidth of the optical source 1 has to be large enough to determine a coherence length of approximately 10 μm in OCT applications and approximately 1 mm for OTDR applications. All the numerical values in the examples above are attainable with the current technology.

In prior art implementations, dispersion of long fiber links prevented considering interference principles to be applied to OTDR instrumentation. In FIG. 7a, at each round trip, light travels through another piece of path length, similar to that explored along the fiber link, and therefore dynamic compensation of dispersion results.

Two pulses at least per pulse in the photodetected signal requires a frequency difference between the object and reference wave of at least 200 MHz for τ=10 ns. This however can be scaled to τ=100 ns, in which case 20 MHz difference may suffice, and a round trip τ=100 ns would require a decent fibre length in each loop of 20 m.

FIG. 7b shows the theoretical power output from a ring 44, based on a single coupler design for two values of the cross coupling ratio relative to the power of the input pulse, left: 10% and right: 1% . The figures also show that the first pulse coming out of the ring 44 has a large power, close to the input pulse power. As conservation of power among multiple roundtrips requires power redistribution among the multiple pulses, a large pulse power is required for the optical source 1. The first pulse therefore, may damage the subsequent optical components. In order to protect the optical amplifiers 33 and 33′ in FIG. 7a, the AOMs in the frequency shifters 23 and 23′ are switched off with a pulse of duration τ, correspondingly delayed using a pulse generator 71. Alternatively, the source 1 is a pulsed laser source and the block 71 is in this case a photodetector, equipped with a shaping circuit with adjustable delays to convey the blocking pulses to the drivers 64 and 64′ of the two frequency shifters, 23 and 23′.

The problem of the first pulse being sent to the two interferometer arms can be addressed by using delay lines as shown in the embodiment in FIG. 7c, similar to the embodiment in FIG. 2i, made of two splitters, 35 and 36, with small cross efficiency, to inject and respectively tap out power from the ring 34. Here the cross efficiency is considered again as an example only, of 1% for both splitters. This means that the ring 34 loses 2% at each roundtrip. After the first roundtrip, 0.01% from the initial power is taped out, then second pulse will extract 0.098% from the initial pulse power and so on, ie all pulses including the first will manifest similar powers, all small, but with the strong initial pulse eliminated. Optical amplification can be placed before or after the passive loops, to compensate for the losses, though not inside of the loops. Powers in excess of 100 mW are now available from large bandwidth sources. Using the coupling example of 0.01%, a pulse with 10 μW optical power will result that can be subsequently amplified in an optical amplifier 33 following the passive loops. Alternatively, the optical source 11 can be a broadband femtosecond pulse source. Let us consider a typical low cost femtosecond pulse operating at 20 MHz with an average power of 100 mW, a pulse-width of 100 fs and a bandwidth of 50 nm The pulses reach a peak power of 500 times the average power, ie 50 W. Some enlargement of the pulses are required, to allow the use of available carrier frequencies of less than 1 GHz. To fit 10 recirculations within the period of 50 ns, a round trip of τ=5 ns is necessary. So the enlargement should be up to 5 ns, compatible with a 400 MHz carrier (to place two cycles within the pulsewidth τₛ).

As the duration of the pulse, τₛ, is set to be less than the roundtrip time of the loop, τ, the loop will ‘output’ a series of pulses of decreasing amplitudes, where the decrease is approximately only 2%, of duration equal to the original pulse length and repeated at a period equal to the roundtrip time of the loop. In this way, the attenuation of power from a roundtrip to the next is reduced to less than 10 log(1/0.98)=0.08 dB, much smaller than 4 dB, the best result achieved with rings using optical amplifications and frequency shifters in L. Neagu, A. Bradu, L. Ma, J. W. Bloor and A. Gh. Podoleanu in Optics Letters Vol. 35, No. 13/Jul. 1, 2010, pp. 2296-2298. As there is no initial strong pulse, no toggle of the AOMs 23 and 23′ is needed, and therefore the two drivers 64 and 64′ operate continuously.

The embodiments in FIGS. 7a and 7c can perform OTDR, by combining the principle of recirculating delay lines with that of low coherence interferometry. In these embodiments the frequency shifters 23 and 23′ are used to create a beat frequency between the arms of the interferometer high enough to allow photodetection of interference during the pulse-width, τₛ. For the example above, of a roundtrip τ=10 ns, in order to have at least two cycles per pulse, the interference signal needs to pulsate at over 100 MHz. This is achievable with the current technology by using AOMs driven at over 100 MHz (330 MHz are known in the art) and using one AOM, for instance 23, shifting the optical frequency up by F_{R} and the other AOM, 23′, shifting the frequency down by F_{O}. In this way, the heterodyne signal at the output of balance detector 9 pulsates at the sum of the frequencies F_{R} and F_{O} of the signals applied to the two

AOMs 23 and 23′ by respective drivers 64 and 64′. Alternatively, only one AOM of high frequency can be used with a second device of similar material placed in the other interferometer arm for dispersion compensation. If femtosecond sources are used, then stretchers should be utilized to increase the pulse width τₛ to more than 2/carrier frequency.

The AOMs 23 and 23′ are driven by single frequency drivers 64 and 64′, excited at F_{O} and F_{R} respectively. For demodulation, the decoder uses a mixer 72a that creates the sum (or the difference) of F_{R} and F_{O} as input to mixer 72b, to serve the demodulation of pulses after the balanced photodetector 9.

In effect, time determination of the interference with respect to the first pulse from the source 1 is used to infer the number of roundtrips in the two rings. In this way, the axial position of the scattering point in 69, or if the embodiment is used for tracking, the axial position of the reflector 69 can be determined The differential delay A between the OPDs in these rings 34 and 34′ determine the separation of sampling positions of the axial position of a mirror 69. For this method, OTDR is used to determine the circulation number, m, while the resolution in the measurement continues to be given by the coherence length of the optical source 1. The circulation number is determined temporally comparing the time of output pulses from 9 with the pulse from optical source 1, using meaning known in the art, such as START/STOP circuits.

As a difference to conventional OTDR, the sampling resolution is determined by the inverse of the optical spectrum width (coherence length), and not by the pulse length. Another difference with conventional OTDR is that if interference is to be used for detection, the source needs to be coherent with a coherence length larger than the axial range. Here, a broadband source is used and the axial range is determined by the number of roundtrips.

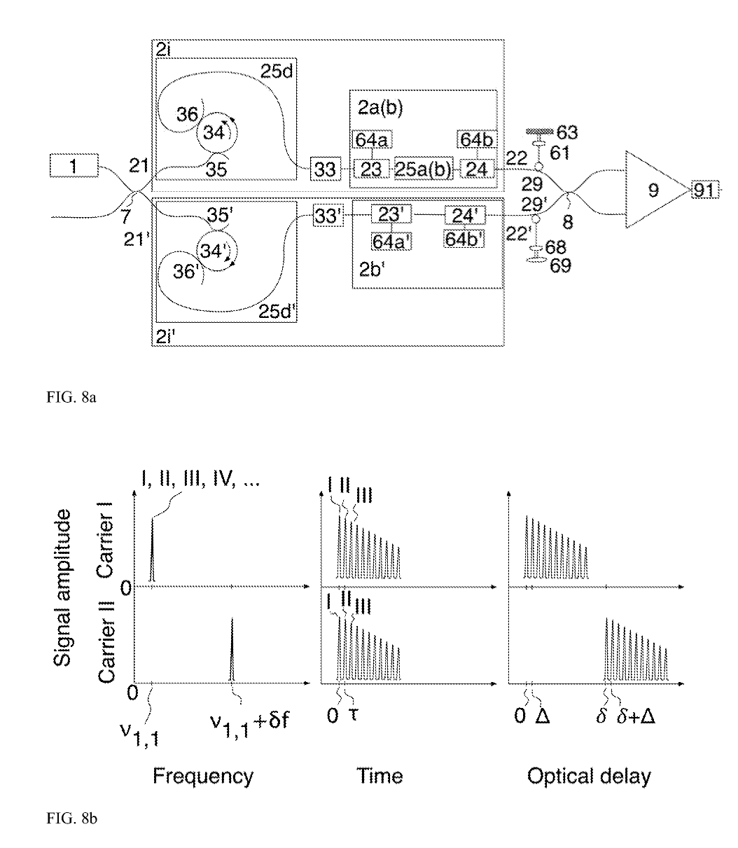

FIG. 8a shows in diagrammatic form, an eighth embodiment of the apparatus according to the invention, based on multiplexers as disclosed in FIG. 2i and where the frequency shifting is outside the multiple delays. This uses a serial combination of passive rings with multiple parallel paths frequency shifters, 23, 24, 23′ and 24′, as for example using the multiplexer 2b.

FIG. 8b shows in diagrammatic form, the succession of interference wave trains output of the embodiment in FIG. 8a. For simplicity, let us consider only two parallel delays in the multiplexer 2b. The pulse from the pulsed source 1 undergoes multiple recirculations in the ring 34 and then the pulse train passes through a multiplexer 2b, where the drivers 64a and 64b excite the AOM 23 at two frequencies, F₂₃ and F₂₃+δf, F₂₄ and F₂₄+δf, where F₂₃=F₂₄. The beam deflected by AOM 23 due to excitation at F₂₃+δf travels along a delay δ introduced by 25b. The pulse train generated in the ring 34 is split into two wave trains, delayed by δ. The pulse train generated in the ring 34′ in the object arm travels along a single path towards the interface optics 68 and object 69. Beating between the two reference waves with the object wave leads to interference signal pulsating at two frequencies:

ν₁₁=F₂₃−F_{23′}+F₂₄−F_{24′} and ν₂₁=F₂₃+δf−F_{23′}+F₂₄+δf−F₂₄=ν₁₁+δf (12a,b)

where F_{23′}=F_{24′}. The embodiment in FIG. 8a operates with two channels, on two frequencies f₁ and f₂ obtained by combination of signals from 2b and 2b′. Channel 1 provides wave trains delayed by multiples of the roundtrip difference between the two rings, 34 and 34′, Δ, pulsating at ν₁₁. Channel 2 provides wave trains pulsating at ν₂₁ and delayed by multiples of Δ again, but all delayed from the wave trains in channel 1 by the much larger delay δ due to 25b. FIG. 8b left shows the frequency difference between the two carriers, in the two channels, 2δf. The delays of the wave trains are shown in FIG. 8 right. Such an arrangement allows to continuously cover long distances by probing each depth with photodetected pulses of similar optical strength. For instance, for Δ=20 μm, considering that in M=20 roundtrips the signal decayed considerably, then δ could be slightly larger than MΔ=400 μm. Pulses in the two channels arrive at the photodetector in 9 at approximately the same time. This is because the delay due to δ in 25b is much smaller than the pulsewidth and therefore, also smaller than the roundtrip time, τ. Let us say that the rings are of 20 cm, so τ˜1 ns. For M=20 roundtrips, it will take T=20 ns to transmit all pulses to the balance detector 9. In the same time, of T=20 ns, 20 pulses from each channel are detected separately as they are on different carriers than the other 20 pulses from the other channel. If more delays are added to 25b, with corresponding more excitation frequencies to 64a and 64b, in the same time T, more depths can be investigated.

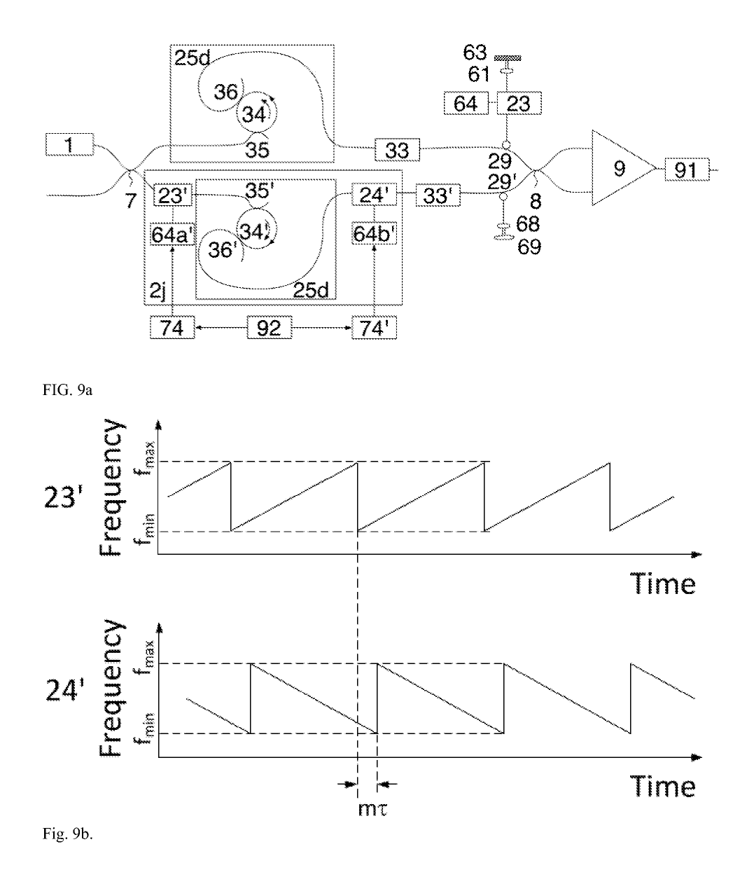

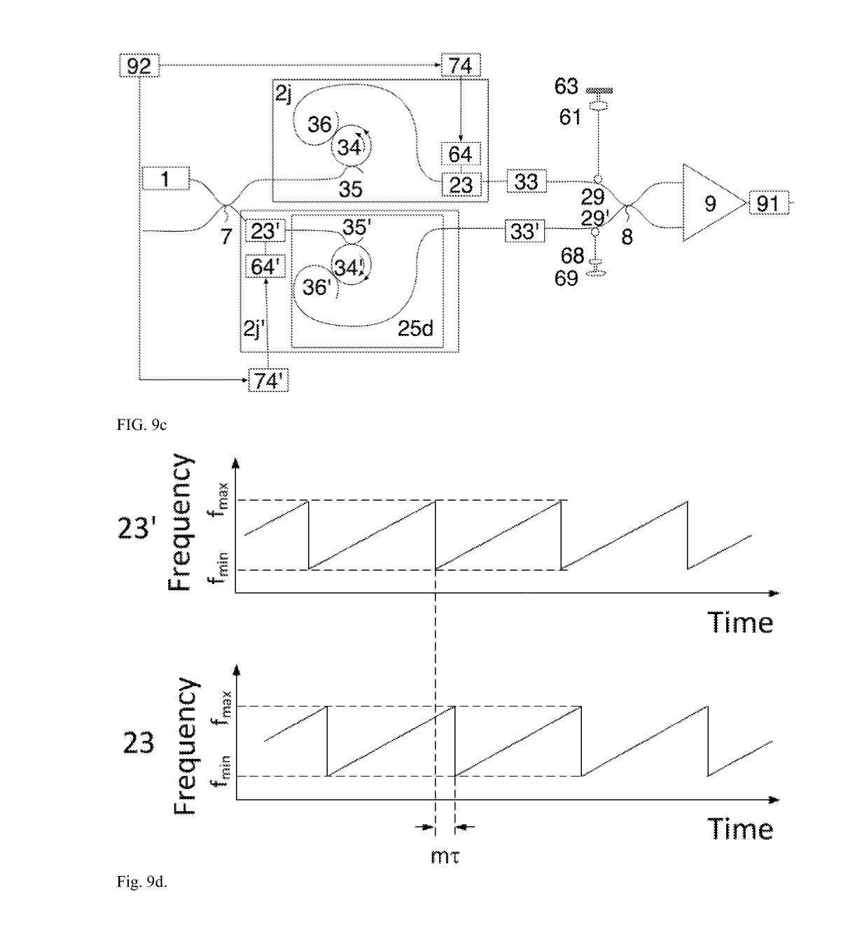

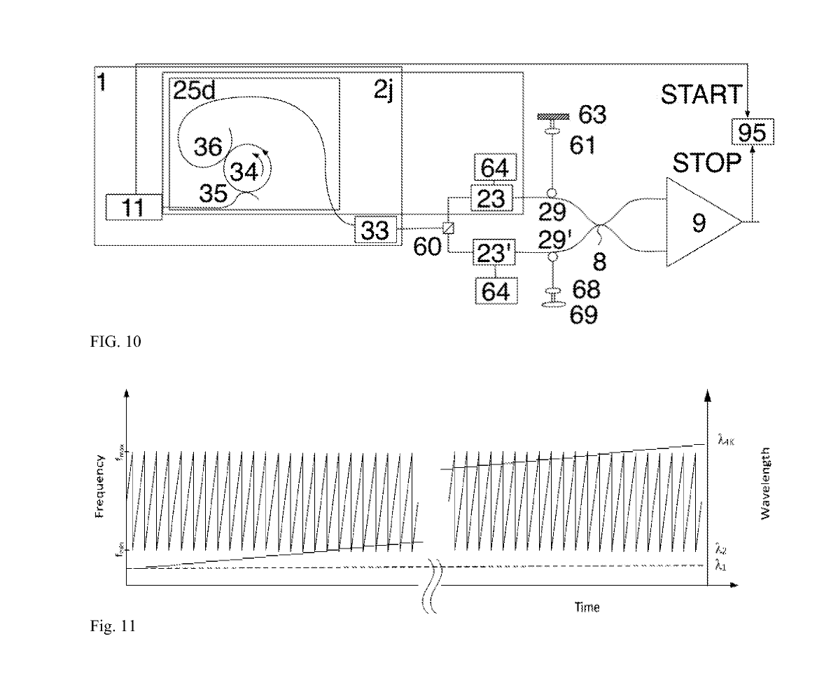

FIG. 9a shows an embodiment, where a multiplexer of type 2j, is placed in the object arm. The frequency shifter, 23′, drives an implementation of the multiple phase elements 25d, based on an optical ring. After each round trip, a new phase change takes place, similar with using several phase elements, however this takes place here sequentially. A first application of such multiple phase elements 25 is in providing stepped delays. Each is interrogated by a different optical frequency due to chirping the frequency of the signal applied to the frequency shifter 23′. Such a modulation technique represents a variant of frequency modulation continuous wave (FMCW) method. FMCW has traditionally been developed around a laser source, whose frequency is chirped. Beating of the local optical signal with the received signal, after traveling an optical path, leads to a beat signal whose frequency is proportional to the optical path length. The frequency beat is due to the instantaneous difference in the chirped frequencies of the two signals. FMCW is used here to determine the number of roundtrips before interference. The frequency shifting is performed again, outside the multiple delays, using rings 34 and 34′ and low cross coupling efficiency directional couplers 35, 36, 35′ and 36′. Here, FMCW is combined with recirculating delay lines and low coherence interferometry. In the bottom path, the object arm, the multiple delay line is between two AOMs, operating as frequency shifters, 23′ and 24′. In the reference arm, a third frequency shifter, 23, is mounted between the circulator 29 and a mirror 63, so light travels twice through 23 and incurs a double frequency shift.

Here the driver 64, delivers a single signal, of frequency F_{R}, to the AOM 23, while the drivers, 74 and 74′ of the AOM 23′ and 24′ respectively produce a ramp variation of the frequency of their exciting signal. They are controlled in synchronism, provided by a pulse generator 92. A pulse generator 92 triggers the chirping of the two oscillator drivers 64 and 64′ determined by two frequency sweep drivers 74 and 74′. Both AOM 23′ and 24′ shift the optical frequency in the same direction, either up or down. The upper graph in FIG. 9b represents the variation of the optical frequency imprinted by the AOM 23′, placed before the ring 34′ and the lower graph in FIG. 9b represents the variation of the optical frequency shift imprinted by the AOM 24′ placed after the ring 34′ in the object arm of the interferometer. Both frequency shifters 23′ and 24′ are swept in synchronism between the same frequencies, but chirped in opposite directions as shown in FIG. 9b, where as reference for the current time is taken the instantaneous frequency shift imprinted by 24′. The top waveform shows the frequency shift due to 23′ delayed by multiple roundtrips in 34′. The roundtrips through the multiple phase elements 34′ act as phase shifts making the overall frequency shift at the output of 9, dependent on the number of roundtrips. The beat frequency resulting from the interference of the object and reference wave is an indicator of how many times the interfering light has gone around the loops 34 and 34′. The time taken to travel from the frequency shifter 23′ to the frequency shifter 24′ determines the carrier frequency of the photodetected signal. FMCW is used here to determine how many times light has circulated around the ring 34′.

Key factors of such an embodiment are:

The sampling resolution is determined by the bandwidth of the broadband optical source 1;

The step size between sampling positions is determined by the difference in the optical path lengths of the loops, 34 and 34′, Δ, in the object and reference paths;

Let us say that the frequency shift of the optical signals at the output of the AOMs varies between fₘᵢₙ and fₘₐₓ and the frequency shift due to the frequency shifter 23 in the reference arm is 2F_{R}. The frequency shift of the optical signal at the output of the first AOM, 23′, is:

F₁=fₘᵢₙ+(t/T)(fₘₐₓ−fₘᵢₙ) (13)

and for the optical signal at the output of the second AOM, 24′, is:

F₂=fₘₐₓ−[(t+mτ)/T](fₘₐₓ−fₘᵢₙ) (14)

In order to ensure a large carrier frequency, the AOM 23 is driven in antiphase to the two AOMs, 23′ and 24′, and the photodetected signal at the output of 9 pulsates at a frequency:

ν=F₁+F₂+2F_{R} (15)

For instance, such adjustment can be achieved when the frequency of the output waves of the AOM 23′ and 24′ is shifted up and the frequency of the AOM 23 is shifted down. Waves with different delay, mτ, originate at the output of the delay line 34. As the two AOMs 23′ and 24′ are excited in synchronism, for each time interval, multiple of the roundtrip τ, the overall frequency shift of the signal at the output of the second AOM, 24′, will differ, depending on the phase shift introduced by the roundtrips in the delay line 34.

By beating signal at different time intervals, a different frequency is obtained at the output of balance detector 9. At coherence, the photodetected signal pulsates at a frequency:

νₘ=fₘᵢₙ+fₘₐₓ+2Fᵣ−(mτ/T)(fₘₐₓ−fₘᵢₙ) (16)

The minimum frequency of the signal output is obtained for the direct transfer of the wave:

νₘᵢₙ=fₘᵢₙ+fₘₐₓ+2F_{R} (17)

After m=M roundtrips, Mτ=T, the frequency bit v reaches the maximum:

νₘₐₓ=fₘᵢₙ+fₘₐₓ+2F_{R}+fₘₐₓ−fₘᵢₙ=2fₘₐₓ+2F_{R} (18a,b)

As example, let us say that fₘᵢₙ=40 MHz, fₘₐₓ=60 MHz and F_{R}=40 MHz. Then, νₘᵢₙ=180 MHz and νₘₐₓ=200 MHz. A difference νₘₐₓ−νₘᵢₙ=20 MHz is utilized to code the number of roundtrips, m. A minimum duration of interaction of 2 cycles in the period 1/νₘᵢₙ=7.14 ns, requires a roundtrip of at least 2/νₘᵢₙ=14 ns. With a bandwidth, B, of 1 MHz in continuous wave (CW) required for en-face OCT imaging, then the number of channels is:

(νₘₐₓ−νₘᵢₙ)/B=M=20 (19a,b)

channels. This requires a period T=Mτ=207 ns=0.14 μs.

Let us say that the reference signal, shifted in frequency by 2F_{R}, travels along the reference path of length L_{R}. This will interfere with the optical signal in the object arm shifted in frequency by fₘᵢₙ+fₘₐₓ, travelling up to the top of the object, along object length L_{O}.

Let us assume that the length of the ring 34, l_{R}, in the reference path is longer than the length of the ring 34′, l_{O} in the object path by, Δ. For an object of index of refraction n, this means that the coherence gate selects signal from a depth z given by:

L_{O}+2nz=L_{R}+mΔ (20)

ie from depths z in the object 69 at:

z=mΔ/(2n)+(L_{R}−L_{O})/(2n) (21)

Let us say that the reference path is adjusted to L_{R}=L_{O}, where L_{O} is the object path up to the top of the object, 69. This gives:

z=mΔ/(2n) (22)

M depths in the object can be interrogated this way, where MΔ defines the axial range of the method. Each depth, zₘ, is encoded on a frequency νₘ. The top of the object is encoded on the beat frequency νₘᵢₙ=180 MHz.

So the frequency is chirped in M steps from fₘᵢₙ to fₘₐₓ and the OPD range is MΔ.

For the embodiment to work, it is required that the differential path length between the two rings 34 and 34′, Δ, is larger than the axial resolution, l_{c}/2, where l_{c} is the coherence length determined by the optical source bandwidth, evaluated in the object 69 (ie after correction for its index of refraction).

Signal for each en-face image is provided in a time τ out of T. Such an embodiment allows scanning in depth an axial range MΔ without any mechanical means. The speed of scanning is 1/T, which, with the numerical example above exceeds 200 kHz. While such A-scan speeds are available now with spectral domain OCT, the embodiment and method disclosed here is scalabale in range to much larger axial ranges than achievable with spectral domain OCT. For instance, Δ can be set to 1 mm, achieving an A-scan with M=20 points from an axial range of MΔ=2 cm. Each channel in depth is encoded in frequency, determined by the difference in the instantaneous chirps between the two AOMs, 23′ and 24′.

If a value T, 10 times larger than that above is used, of 4 μs, M becomes 10 times larger, 200 on the expense of the bandwidth B, according to (12a), reduced to 100 kHz. The signal for each channel continues to be produced in a time interval τ only out of the total T. Due to this peculiarity, the optical source 1 can be a pulse and not a CW source, emitting pulses at a repetition rate T and of τ duration. Obviously, the repetition period may be larger than T, if safety reasons requires this. Synchronism needs to be secured between pulse emission and start of the waveforms in FIG. 9b.

Obviously, the AOM 23 could have been placed in any other place along the reference path. Also, the multiplexer 2 could have been placed in the reference arm instead and a third AOM driven at a fixed frequency, in the object arm.

Another embodiment according to the invention is disclosed in FIG. 9c. Here, in the object arm, only one AOM, 23′ is placed before the multiple delay line, 34′, and in the reference path, the AOM 23 is placed after the multiple delay line 34. A pulse generator 92 triggers the chirping of the two oscillator drivers 64 and 64′ determined by two frequency sweep drivers 74 and 74′. The two frequencies are ramped over a range from fₘᵢₙ to fₘₐₓ as in FIG. 9d, where as reference for the current time is taken the instantaneous frequency shift imprinted by 23.

The frequency of the optical signal at the output of the first AOM, 23′, is shifted up by:

F₁=fₘᵢₙ+(t/T)(fₘₐₓ−fₘᵢₙ) (23)

and the optical signal at the output of the AOM 23 is shifted up by:

F₂=fₘᵢₙ+[(t+mτ)/T](fₘₐₓ−fₘᵢₙ) (24)

As the two AOMs 23′ and 24′ are excited in synchronism, for each round trip through the two rings 34 and 34′, a multiple MT delay will accumulate, so the overall frequency shift of the interference signal after 9 will differ, depending on the number of roundtrips, m:

νₘ=F₂−F₁=fₘₐₓ−fₘᵢₙ+(mτ/T)(fₘₐₓ−fₘᵢₙ) (25)

After m=M roundtrips, Mτ=T, the frequency bit v reaches the maximum:

ν_{M}=2(fₘₐₓ−fₘᵢₙ) (26)

As example, let us say that fₘᵢₙ=40 MHz, fₘₐₓ=60 MHz. Then, vₘᵢₙ=20 MHz and νₘₐₓ=40 MHz. A difference νₘₐₓ−νₘᵢₙ=20 MHz is utilized to code the number of roundtrips, m. A minimum duration of interaction of 2 cycles in the period 1/νₘᵢₙ=50 ns, requires a roundtrip of at least 2/νₘᵢₙ=100 ns. With a bandwidth, B, of 1 MHz in CW required for en-face OCT imaging, then (νₘₐₓ−νₘᵢₙ)/B=M=20 channels. This requires a period T=Mτ=20 100 ns=2 μs.

FIG. 10 shows in diagrammatic form, an embodiment where the frequency shifting is again performed outside the multiple phase element. Here, FMCW is combined with recirculating delay lines and low coherence interferometry. The optical source block, 1, is made from a pulsed, circularly polarized broadband optical source, 11, whose output signal is sent to a splitter, 35, that drives a polarization sensitive passive ring, 34, wherefrom signal is tapped out via splitter 36. The ring 34 delays optical waves of different linear polarization orientation along a different optical length, towards the output of the optical source block, and where the first splitter is a two outputs polarization separation beam splitter, 60, that provides a linear polarized state at each output. The two output polarized states are orthogonal on each other. The aim is to transfer a well identified polarization state through the ring, 34, picking up a delay corresponding to the orientation of that polarization state in respect to the fast or slow axes of the ring. The ring 34 is shown made of fiber, in this case, any polarization maintaining (PM) fiber can be used. Alternatively, a bulk embodiment can be devised for better stability of parameters, for instance using a Sagnac configuration with 4 splitters. The group of splitters 35 and 36 and ring 34 implement a multiple phase element. The ring can be considered as an infinite number of pairs of phase elements superposed, implementing each a specific delay, depending on the roundtrip length for a corresponding orientation of polarisation. All the waves out of the infinite numbers pairs of phase elements travel towards the frequency shifter 23, placed in the reference path, acting as a reference frequency shifter, then to circulator 29, lens 61 and mirror 63. The object wave travels along the object path consisting in an object frequency shifter 23′, circulator 29′, interface optics 68 and object 69. For short pulse duration operation, the beating frequency ν needs to be high, in which case, 23 and 23′ operate by shifting the optical frequency in opposite directions, one up and the other down. With a maximum shift of 300 MHz, v can be as high as 600 MHz.

### Tracking the Position of a Fast Moving Reflector and OTDR

Let us consider an application, where the object 69 is a mirror and the embodiments in FIG. 9a, 9c or 10 are used to measure the instantaneous distance to it. Here the distance is coded in the time delay between the optical source pulse and the photodetected beating signal pulse. The resolution of the method is given by the recirculation time, τ, through the loop 34 in FIG. 10 and through loops 34 and 34′ in FIGS. 9a and 9c. To this goal, a digital clock block is used, 95, with START given by the optical source pulse and STOP given by the beat signal. Other means known in the art can be used for 95, such as a duration to amplitude converter. To this goal, a trigger Schmidt, 95, can be used in FIG. 10 (which could be added to the other embodiments in FIGS. 7a, 7c and 8a depending on their regime of operation), switched on with the launched pulse from the source, delayed correspondingly to compensate for the optical and electronic delay, and switched off with the pulse from the photodetector signal provided by a rectifier in 9. In this way, the axial distance of the reflector, 69, is converted into duration of pulses at the output of 95. An integrator of the photodetected signal can provide a magnitude proportional to the pulse width so generated. In the PCT application WO/2009/106884A1 UKPO, 0803559.4, by Podoleanu, active loops were used and only a limited number of recirculations could be achieved. Here, passive loops are used instead for more uniformity among the channels, as shown in FIGS. 7a and 7c or a single passive PM loop in FIG. 10.

### Swept Source Interrogation

As mentioned above, the difference path between the multiple paths in the rings, A, can be made much larger than the coherence length, l_{c}, of the broadband optical source 1, in which case the embodiments above in FIGS. 7a, 7c and 10 collect data from sparse points placed at depths in the object, separated by Δ (measured in air). To complete the A-scan in depth for missing points in the example above, swept source interrogation can be applied. The optical frequency variation relative to the RF chirping is illustrated in FIG. 11. A stepped variation of the wavelengths of the swept source 11 from λ₁ to λ_{4K} is shown. On each step, the frequency of the two signals applied to the two frequency shifters 23′ and 24′ in FIG. 9a or 23 and 23′ in FIG. 9c is chirped from fₘᵢₙ to fₘₐₓ.

The axial resolution is now determined by the tuning range Δλ. Using principles of swept source interferometry, multiple A-scans can be generated, replicated by the number M of multiple delay channels in the embodiments presented. Let us say that as in the numerical example above in connection with FIG. 9a, an axial range of 60 mm was covered with sparse 60 points separated by Δz=1 mm, and the coherence length was much smaller, l_{c}=10 μm, which gives a sparse factor Δ/l_{c}=K=100. To cover the A-scan with information between the M=60 points, we need to achieve an axial range of Δz, possible by using swept source interrogation. In this case, the line-width of the swept source needs to be: δλ<λ²/(4Δz). The tuning bandwidth Δλ of the source 1 to determine a depth resolution of l_{c}/2 is λ²/l_{c}. Combining the previous equations leads to a number of at least 4K=400 optical frequency points, obtained by repeating the acquisitions as described above, where each time, the frequency is shifted by an increment Δλ/(4K). For each frequency slot, k, M=60 interference pulses are acquired and stored i_{k,m}. A total of 4KM=24,000 measurements are made, by collecting M interference signals repeated for 4K different optical frequency. Then, the pulses i_{k,m} with k=1 to 4K for each m are used to infer an optical spectrum, Sₘ. FFT of Sₘ delivers an A-scan corresponding to the axial range (m−1)Δ to mΔ. FFT of S₁ delivers an axial range for 0 to Δ=1 mm FFT of S₆₀ delivers the axial range from 59 to 60 mm In this way, multiple OPD values can be simultaneously scanned along an axial distance determined by the source line-width, δλ.

The foregoing description has been presented for the sake of illustration and description only. As such, it is not intended to be exhaustive or to limit the invention to the precise form disclosed. For example, reference was primarily made to measurements and imaging in reflection, however measurements and imaging in transmission could equally be performed. Several examples have been given on using the multipath interferometer configuration in time domain OCT and spectral domain OCT. These are not exhaustive, have been presented as a matter of example and modifications and variations are possible in light of the above teaching which are considered to be within the scope of the present invention. Thus, it is to be understood that the claims appended hereto are intended to cover such modifications and variations, which fall within the true scope of the invention.

For instance, the optical source 11 in the optical source block, 1, can be any of broadband or tunable narrow band optical source, a semiconductor amplifier or a fiber amplifier.

In the embodiments above, where simultaneous multiple path interrogation was meant, this may also refer to multiple flow measurements. Displacement speed values of liquids inside vessels and pipes can be deteremined simultaneously, where the multiple channels can be used to sample the flow at different depths inside the vessel diameter. The optical source 1 can be broadband or narrow tunable, leading to a different signal frequency in each channel depending on the local speed inside the vessel at the depth interrogated.

Other modifications and alterations may be used in the design and manufacture of the apparatus of the present invention and in the application of the methods disclosed without departing from the spirit and scope of the accompanying claims.

Variations include the grouping of recirculation optical loops with a main loop, via a splitter or two splitters where some of the elements are placed in the shared path between the recirculation loop and the main loop.

Variations may also include the grouping of optical devices in the recirculating loops, such as optical modulators (at least one of the following: frequency shifter, amplitude modulator, phase modulator, polarization modulator, spectral scanning delay line) with optical amplifiers.

The optical source can be pulsed with pulses of width less or larger than the recirculating time of the optical wave through each of the recirculation loop. The optical source may also be continuous, operating in CW regime.

Variations may also include the operation of the invention in sensing or OCT imaging.

Variations include the photodetection unit, which may consist of at least one photodetector, and/or two photodetectors whose electrical signals are subtracted one from the other in a balance detection configuration. A spectrometer, or two spectrometers in balance configuration can be used, in case spectral OCT principles are implemented in those embodiments.

Frequency shifters have been mentioned, as acoustooptic modulators, other means can be used, such as in-fibre frequency shifters, or moving mirrors, or fluids, or spectral scanning delay lines, using a diffraction grating and a scanning mirror as exemplified in the patent “Transmissive scanning delay line for optical coherence tomography”, U.S. Pat. No. 7,417,741.

It should be also obvious for those skilled in the art, that the desired frequency shifting may be achieved by using either a single frequency shifter or several frequency shifters. The later is preferred to compensate for the dispersion in the two interferometer arms. Difference or summation of the frequency shifts can be employed by choosing frequency shifting up or down when constructing the acousto-optic modulators. Selection of the difference of frequencies, |F_{O}−F_{R}| is preferred for allowing the photodetector unit 9 work on lower frequency values. In some applications it may be desirable to operate on the sum of the two frequencies, with ΔF=F_{O}+F_{R}, to ensure a sufficiently number of oscillating periods within a limited pulse-width pulse when working in pulses.

The object may be considered as a succession of sensing points that each needs interrogation. Using principles disclosed here, these sensors could be interrogated sequentially or in parallel by using multiple delays to match the position in the object of each such sensor.

Optical delays can be implemented in several ways known in the art. Multiple phase delay elements can include an array of different refractive index elements or an array of active optical elements where the index of refraction can be actively controlled.

1. Optical mapping apparatus, consisting in an optical source block, a first splitter, dividing the light from the optical source block into two arms, a reference arm and an object arm, arms which recombine in a second splitter, terminated with a photodetector unit and a decoder, and where in the object path, an object under investigation is placed in reflection via a third splitter, the apparatus further consisting in a multiplexer comprising a frequency shifter and a multiple phase element made from several optical elements, where all phase elements are being traversed by signal from the frequency shifter if placed after it, or signals from the phase elements traverse all the frequency shifter if this is placed after the multiple phase element.

2. Optical mapping apparatus according to claim 1 where each phase element in the multiple phase element is traversed by a signal shifted in frequency with a different quantity by the said frequency shifter and where the decoder demodulates the signal delivered by the photodetected to provide a separate signal pulsating at a different frequency for each phase element.

3. Optical mapping apparatus according to claim 1, where the frequency shifter is an acoustooptic modulator, driven by a number of N signals of different frequencies, that deflects the incident beam into N beams, shifted in frequency with a different frequency, determined by the frequency of signals applied, and the multiplexer, supplementary contains a first lens, a second lens placed at a distance equal to the sum of focal lengths of first lens and second lens and where at a distance approximately equal to the focal length of the second lens, a second acousto-optical modulator is placed, driven by the same signals driving the frequency shifter, and where the said phase elements are placed between the two lenses, with a phase element for each beam out of the N beams.

4. Optical mapping apparatus according to claim 1, where the multiplexer consists in a circulator, driving the said frequency shifter, where the frequency shifter is an acoustooptic modulator, driven by a number of N signals of different frequencies, that deflects the incident beam into N beams, shifted in frequency with a different frequency, determined by the frequency of signals applied, a lens, and where at a distance approximately equal to the focal length of the lens, a mirror is placed, and where the said phase elements are placed between the lens and the mirror.

5. Optical mapping apparatus according to claim 1, where the multiple phase element consists in several phase elements that implement optical delays, preferentially disturbing the polarization of the incident beams in the same way.

6. Optical mapping apparatus according to claim 1, where the multiple phase element consists in several phase elements that implement each a different polarization alteration, preferentially of similar optical length, where each element can be any of a polarizer or a wave plate with a specific orientation.

7. Optical mapping apparatus according to claim 1, where the multiplexer is placed in the reference path, and therefore is driven simultaneously by several, P, radio frequency signals of different frequency, νₚ, where p=1 to P, and where the said phase elements consist in an array of P phase elements of different optical paths, dₚ, implementing an optical delay for each diffracted beam and where in the object arm at least an object acousto-optic modulator is employed, driven by a single radio frequency signal of frequency fₒ, and where the said photodetector unit outputs an interference signal pulsating at a frequency νₚ=|2fₚ−fₒ|, where each frequency νₚ encodes signal from a certain depth, zₚ in the said object, separated by the difference in the optical thickness of the elements in the array, (dₚ₊₁−dₚ)/n=δ/n, where n is the index of refraction of the object.

8. Optical mapping apparatus according to claim 7, where the optical source block is a swept source tuned in frequency at a scanning rate G(Hz/mm) and where the difference in optical path between steps dₚ₊₁ and dₚ in the array of P phase elements is adjusted close to the axial range determined by the linewidth of the swept source and where the difference of frequencies vₚ₊₁−vₚ is adjusted in accordance with |νₚ₊₁−vₚ|=G|dₚ₊₁−dₚ| to achieve independent sensitivity versus the depth in the object.

9. Optical mapping apparatus according to claim 1, where the multiplexer is connected additionally to a ring of optical length, L_{R}, equipped with a frequency shifter, shifting the optical frequency of the optical signal by F_{R} for each round trip through the ring and where in the object path, additionally a ring of optical length, L_{O}, equipped with a frequency shifter, shifting the optical frequency of the optical signal by F_{O} for each round trip through the ring and where optionally, the two rings may contain an optical amplifier each, and where the photodetector unit outputs an interference signal pulsating at a frequency ν_{p,m}=(2fₚ−fₒ)+m|F_{R}−F_{O}|, where each frequency ν_{p,m} encodes signal from depths z_{p,m}=|pδ+m(L_{O}−L_{R})| in the said object, where m is the number of roundtrips through the two rings.

10. Optical mapping apparatus according to claim 1, where the multiplexer is placed in the reference path, and is driven simultaneously by several, P, radio frequency signals of different frequency, vₚ, where p=1 to P, and where the said phase elements consist in an array of P phase elements that can be any component out of a linear polarizer or a wave plate, and where the optical path of all individual phase elements is essentially the same, and where in the object arm at least an object acousto-optic modulator is employed, driven by a single radio frequency signal of frequency fₒ, and where the said photodetector unit outputs an interference signal pulsating at a frequency vₚ=|2fₚ−fₒ|, where each frequency νₚ encodes signal from the same depth in the object, but of a p different polarization state.

11. Optical mapping apparatus according to claim 1, where the multiplexer is placed in the object arm, and where the said multiple phase element consists in optical delays taking place in multiple paths, m, through an optical object passive ring of optical length L_{O}, of optical path differences mL_{O} and where a second frequency shifter is placed in the multiplexer after the object passive ring, and where the two frequency shifters are driven by teo drivers with signals of frequency changed in synchronism by saw-tooth signals of opposite polarity, of period T=mL_{O}/c, where c is the speed of light in the ring, one shifting the frequency from a minimum frequency fₘᵢₙ to a maximum frequency fₘₐₓ, and the other frequency shifter shifting the frequency from fₘₐₓ to fₘᵢₙ, and where in the reference path, a reference passive ring of length L_{R} is placed, and where interference is produced between a reference wave in the reference path and an object wave in the object path that have traveled the same number of roundtrips, m, in the two passive rings, and where the object wave producing interference is produced by points in the object, separated in the object by an axial differential distance (L_{R}−L_{O})/(2n), where n is the index of refraction of the object and where the said decoder separates the interference signals from the different depths M in the object based on the difference of the chirp in the shifting frequencies in steps m(fₘₐₓ−fₘᵢₙ)/M.

12. Optical mapping apparatus according to claim 1, where an optical ring equipped with a frequency shifter is mounted in the optical source block, driven by a broadband source.

13. Optical mapping apparatus according to claim 1, where the optical source block consists in a broad band optical amplifier inside an optical ring equipped with a frequency shifter.

14. Optical mapping apparatus according to claim 1, where the optical source block consists in a tunable optical source.

15. Optical mapping apparatus according to claim 1, where a transversal scanner is used in the object arm to scan the object beam over the object in at least one direction and the apparatus produces multiple OCT images, as determined by the multiplexer.

16. Method for providing multiple measurements from inside an object subject to investigation, where the optical wave from an optical source is divided into two arms forming an interferometer, object and reference arms of the interferometer, where the object arm contains the object, and where the wave in at least one of the arm is shifted in frequency in a frequency shifter that drives multiple delays, before suffering interference with the wave from the other arm to provide a photodetected signal containing pulsating signals at a different frequency for each delay.

17. Method for providing multiple measurements according to claim 16, where the shifting in frequency in the reference arm is performed discretely, at several discrete steps, simultaneously, and the wave of a given frequency shift is spatially separated from the wave of a different frequency shift, and where each such wave suffers different phase change by encountering a different phase element, that can be either from the category of waveplates or polarization components, and where all phase elements are of similar optical thickness and where the multiple measurements are coded on the frequency of the photodetected signal, providing simultaneously multiple polarization measurements from the same depth in the object.

18. Method for providing multiple measurements according to claim 16, where the shifting in frequency in the reference arm is performed discretely, at several discrete steps, simultaneously, and the wave of a given frequency shift is spatially separated from the wave of a different frequency shift, and where each such wave encounters a different optical path delay element, providing simultaneously multiple measurements from different depths in the object.

19. Method for providing multiple measurements from inside an object subject to investigation, where the optical wave from an optical source is divided into two arms forming an interferometer, object and reference arms of the interferometer, where the object arm contains the object, and where the wave in each arm suffers sequentially separate multiple delays to provide a delayed wave for each such delay, and then all such waves in at least one arm being shifted in frequency in a frequency shifter and then suffering interference with the wave from the other arm to provide a photodetected signal containing pulsating signals at a frequency determined by the frequency shifter but arriving at a different time for each delay.

20. Method for providing multiple measurements according to claim 19, where the shifting in frequency is performed continuously at a chirp rate, and where the chirped waves traverse a first optical ring, and where a second optical ring is inserted in the other arm, of lengths differing through an increment A from the length of the first ring, and where multiple measurements, m, from different depths in the object are provided, measurements separated by A/n, where n is the index of refraction of the object, each measurement being coded on the frequency of the multiple photodetected signals, pulsating at a frequency corresponding to the chirp rate and the number m, of roundtrips suffered by the object and reference waves through the two rings, determining signal from a depth advanced in the object by mΔ/n.
